(19) United States
(12) Patent Application Publication
(10) Pub. No.: US 2025/0374234 A1
(43) Pub. Date: Dec. 4, 2025

(54) HANDHELD DIRECTIONAL WIFI SCANNING APPARATUS

(71) Applicant: WarCollar Industries, LLC, Reston, VA (US)

(72) Inventor: Eugene J. BRANSFIELD, JR., Reston, VA (US)

(21) Appl. No.: 18/679,088

(22) Filed: May 30, 2024

(51) Int. Cl. H04W 64/00; H04W 8/00

(52) U.S. Cl. CPC H04W 64/006; H04W 8/005

(57) ABSTRACT

A WiFi scanning apparatus can comprise a housing defining a pointing direction for collecting WiFi or Bluetooth packets. A directional antenna disposed within the housing can provide directionality for increased gain in the pointing direction along a longitudinal axis of the housing. A WiFi chipset module coupled to the directional antenna can be configured to obtain a plurality of collected packets from one or more access points (APs) in the pointing direction, using the directional antenna. A positioning system can be configured to determine a location and a heading orientation of the apparatus corresponding to a time of collection for each collected packet of the plurality of collected packets. A system-on-module (SOM) can generate WiFi scan data comprising the plurality of collected packets and a respective geolocation metadata indicative of the location and the heading orientation determined for each collected packet of the plurality of collected packets.

### FIELD

The present disclosure generally relates to wireless communications. For example, aspects of the present disclosure are related to systems and techniques for WiFi scanning using a handheld device to perform packet collection with positioning information.

### BACKGROUND

Wireless communications systems are deployed to provide various telecommunication services, including telephony, video, data, messaging, broadcasts, among others. These systems may be multiple-access systems capable of supporting communication with multiple users by sharing the available system resources (e.g., such as time, frequency, and power). Multiple-access systems can be based on code division multiple access (CDMA), frequency division multiple access (FDMA), time division multiple access (TDMA), and orthogonal frequency division multiple access (OFDMA), etc.

A wireless network, for example a wireless local area network (WLAN), such as a Wi-Fi (e.g., Institute of Electrical and Electronics Engineers (IEEE) 802.11) network may include one or more access points (APs) that may communicate with one or more stations (STAs) or mobile devices. The one or more APs may provide a shared wireless communication medium for use by multiple STAs. An AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via downlink (DL) and uplink (UL). The DL (or forward link) may refer to the communication link from the AP to the station, and the UL (or reverse link) may refer to the communication link from the station to the AP.

### BRIEF SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for performing wireless communication. According to at least one illustrative example, an apparatus for wireless communications is provided. The apparatus includes a housing defining an enclosed volume and a pointing direction of the apparatus, wherein the pointing direction corresponds to a longitudinal axis of the housing; one or more directional antennas disposed within the enclosed volume of the housing, wherein the one or more directional antennas are configured to provide directionality for increased gain in the pointing direction of the apparatus along the longitudinal axis; a WiFi chipset module coupled to the one or more directional antennas and configured to collect a plurality of collected packets from one or more access points (APs) in the pointing direction of the apparatus using the one or more directional antennas; a positioning system configured to determine a location and a heading orientation of the apparatus corresponding to a time of collection for each collected packet of the plurality of collected packets; and a system-on-module (SOM) communicatively coupled to the WiFi chipset module and the positioning system, wherein the SOM generates WiFi scan data comprising the plurality of collected packets and a respective geolocation metadata indicative of the location and the heading orientation determined for each collected packet of the plurality of collected packets.

In some aspects, the respective geolocation metadata for each collected packet comprises Per Packet Information (PPI) data.

In some aspects, the WiFi scan data comprises packet capture (PCAP) data, and wherein the respective geolocation metadata for each collected packet comprises Per Packet Information (PPI) data embedded within the PCAP data.

In some aspects, the respective geolocation metadata for each collected packet further includes one or more of: an altitude of the apparatus corresponding to the time of collection of each collected packet; or an angle of attack associated with the apparatus receiving the collected packet using the one or more directional antennas.

In some aspects, the positioning system comprises: a Global Navigation Satellite System (GNSS) receiver and a corresponding GNSS antenna, wherein the location of the apparatus corresponding to the time of collection for each collected packet is determined by the GNSS receiver in response to a query from the SOM.

In some aspects, the GNSS receiver comprises a Global Positioning System (GPS) receiver, and wherein the corresponding GNSS antenna comprises a GPS antenna

In some aspects, the positioning system comprises a magnetic compass configured to determine the heading orientation of the apparatus corresponding to the time of collection for each collected packet, and wherein the heading orientation is determined by the magnetic compass in response to a query from the SOM.

In some aspects, the positioning system includes one or more of a magnetometer or an accelerometer; and the respective geolocation metadata determined for each collected packet further includes one or more of a respective magnetic field information determined using the magnetometer at the time of collection for each collected packet, or a respective acceleration information determined using the accelerometer at the time of collection for each collected packet.

In some aspects, the apparatus further comprises a Bluetooth chipset module coupled to the one or more directional antennas and configured to collect a plurality of Bluetooth packets from one or more Bluetooth devices in the pointing direction of the apparatus, using the one or more directional antennas.

In some aspects, the WiFi chipset is configured by the SOM to perform WiFi scanning operations in the pointing direction, based on using one or more WiFi directional antennas included in the one or more directional antennas.

In some aspects, the one or more directional antennas includes at least a first WiFi directional antenna configured to perform WiFi scanning operations for collecting WiFi packets associated with a first WiFi band, and a second WiFi directional antenna configured to perform WiFi scanning operations for collecting WiFi packets associated with a second WiFi band.

In some aspects, the first WiFi directional antenna is associated with collecting WiFi packets on a 2.4 gigahertz (GHz) WiFi band, and the second WiFi directional antenna is associated with collecting WiFi packets on a 5 GHz WiFi band.

In some aspects, the Bluetooth chipset module is configured to perform Bluetooth scanning operations in the pointing direction, based on using one or more Bluetooth directional antennas included in the one or more directional antennas.

In some aspects, the one or more directional antennas includes at least a first Bluetooth directional antenna configured to collect Bluetooth or Bluetooth Low Energy (BLE) packets transmitted from Bluetooth devices in the pointing direction of the apparatus.

In some aspects, the SOM is a Linux-based SOM and provides a user interface for implementing one or more user configuration inputs corresponding to WiFi scanning or packet collection operations of the apparatus.

In some aspects, the apparatus is configured to perform WiFi scanning or WiFi sniffing based on one or more of enabling a monitor mode of the WiFi chipset module, or performing packet injection using the WiFi chipset module.

In some aspects, the apparatus further comprises an external optic coupled to an outer surface of the housing, wherein an optical viewing axis of the external optic is aligned with the pointing direction of the apparatus and the longitudinal axis of the housing.

In some aspects, the external optic comprises a monocular or a spotting scope detachably coupled to the outer surface of the housing.

In some aspects, a field of view of the external optic corresponds to an area of maximum gain of the one or more directional antennas in the pointing direction of the apparatus.

In some aspects, the housing comprises a handheld enclosure formed from radio frequency (RF) transparent materials; and the apparatus further includes a rechargeable battery disposed within the enclosed volume of the housing and configured to power the apparatus during WiFi or Bluetooth scanning and packet collection operations.

Aspects generally include a method, apparatus, system, computer program product, non-transitory computer-readable medium, user equipment, base station, wireless communication device, and/or processing system as substantially described herein with reference to and as illustrated by the drawings and specification. In some aspects, one or more of the apparatuses described above is or is part of a camera, a mobile device (e.g., a mobile telephone or so-called “smart phone” or other mobile device), a vehicle or computing system or device of a vehicle, a wearable device, an extended reality device (e.g., a virtual reality (VR) device, an augmented reality (AR) device, or a mixed reality (MR) device), a personal computer, a laptop computer, a server computer, or other device.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following drawing figures:

FIG. 1 is a block diagram illustrating an example wireless communication network, in accordance with some examples;

FIG. 2A is a block diagram of a wireless communication device that can implement a station (STA) or access point (AP), in accordance with some examples;

FIG. 2B is a schematic block diagram of the receiver data flow architecture of the wireless communication device of FIG. 2A, in accordance with some examples;

FIG. 3 is a block diagram illustrating an example architecture of a handheld WiFi scanning apparatus, in accordance with some examples;

FIG. 4A illustrates a first perspective view of an example handheld WiFi scanning apparatus, in accordance with some examples;

FIG. 4B illustrates a second perspective view of the example handheld WiFi scanning apparatus of FIG. 4A, in accordance with some examples;

FIG. 4C illustrates an example internal display that may be included in the example handheld WiFi scanning apparatus, in accordance with some examples;

FIGS. 5A-5C illustrate various perspective views of a directional antenna of a handheld WiFi scanning apparatus, in accordance with some examples;

FIG. 6 is a diagram illustrating a first example of WiFi scan results, in accordance with some examples;

FIG. 7 is a diagram illustrating a plurality of WiFi scan locations, in accordance with some examples;

FIG. 8 is a diagram illustrating an example of a WiFi scan associated with a reflection of one or more WiFi packets, in accordance with some examples;

FIG. 9 is a diagram illustrating an example of WiFi scan data obtained from a plurality of scan locations and associated with Per Packet Information (PPI), in accordance with some examples;

FIG. 10 is a diagram illustrating another example of WiFi scan data obtained from a plurality of scan locations and associated with Per Packet Information (PPI), in accordance with some examples; and

FIG. 11 is a block diagram illustrating an example of a computing system for implementing certain aspects described herein, in accordance with some examples.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

A WiFi network can utilize different frames (e.g., different frame types and/or different frame structures) for wireless communications. WiFi frames may also be referred to as datagrams or L2 datagrams. In one illustrative example, a WiFi network can utilize management frames, control frames, and data frames. Management frames can be used to manage a basic service set (BSS), control frames can be used to control access to the physical transmission medium, and data frames can be used to transmit payload data. WiFi frames may include a Media Access Control (MAC) header, a payload, and a frame check sequence (FCS). In some cases, a WiFi frame may be generated (e.g., transmitted, received, etc.) without including a payload. In some examples, the first two bytes of the MAC header can be indicative of a frame control field specifying the form and function of the frame. For example, the frame control field can include one or more bits indicative of the type of the associated WiFi frame (e.g., management frame, control frame, data frame). In some cases, the frame control field can include two bits that are indicative of the frame type of the WiFi frame that includes the MAC header (e.g., which itself includes the frame control field bits).

The MAC header of a WiFi frame can additionally include a sequence control field. The sequence control field is a two-byte section that can be used to indicate or identify message order and/or to eliminate duplicate frames. WiFi frames transmitted between a given AP-STA pair (e.g., an access point (AP) and a connected client thereof, also referred to as a station (STA)) can each be associated with a unique sequence control value, which can be maintained and incremented as a separate sequence (e.g., counter) for each different AP-STA pair that uses one or more Wi-Fi frames to perform wireless communications with one another.

WiFi sniffing techniques can be used for various networking monitoring and analysis purposes, including performing WiFi surveys and/or WiFi penetration testing. As used herein, WiFi sniffing can also be referred to as WiFi scanning or WiFi collection, and may involve the capture and analysis of one or more packets that are transmitted over a WiFi network of interest. For example, a WiFi sniffing apparatus (e.g., a WiFi scanning apparatus) can be used to capture packets that are transmitted on one or more networks that are within range of the WiFi sniffing apparatus.

To capture packets, a WiFi sniffer can utilize a monitoring mode that allows the device to capture or otherwise obtain all wireless traffic that is within range, across multiple channels (e.g., including the packets and wireless traffic that are not directed or addressed specifically to the WiFi sniffer device). In the monitoring mode, the WiFi sniffer device is not necessarily associated with a particular wireless access point (AP), and is instead configured to capture packets to or from any AP and WiFi network that is within range (e.g., that can be detected and received using one or more antennas, radios, WiFi receivers, etc., included in or otherwise implemented by the WiFi sniffer device).

For example, a WiFi sniffer or WiFi scanning device can perform a continual (or periodic) scan of the advertised networks that are within range of the device. Based on capturing various packets and or WiFi frames (e.g., management frames, control frames, or data frames), the WiFi sniffer can determine information associated with the WiFi networks that are within range. This information can include, but is not limited to, information such as the service set identifier (SSID) of the network, the media access control (MAC) addresses of connected devices and/or APs of the network, data payloads transmitted over the network, security or encryption information (e.g., encryption type, etc.,) utilized or implemented by the network, etc.

The packets and information obtained using a WiFi sniffer or WiFi scanning device can be used for various purposes, such as network troubleshooting, performance analysis, security assessments or penetration testing, etc. In some cases, one or more WiFi scans can be performed to identify and/or locate rogue WiFi APs. For example, WiFi scans can be performed at various different locations, with each WiFi scan used to determine a listing of all APs that are within range (e.g., all APs that transmit or receive one or more packets that are captured by the sniffer device during that particular WiFi scan). The listing of observed APs from the one or more WiFi scans can be compared with a listing of known or expected APs, to thereby identify and locate any rogue WiFi APs that may be present.

In another example, WiFi sniffing can be used to identify and locate any unknown or unauthorized hidden WiFi APs that may be present. A hidden WiFi AP is an AP that is configured to not broadcast an SSID (by default, most WiFi networks and APs are configured to broadcast a beacon frame indicative of the SSID(s) approximately every 100 milliseconds (ms). To detect hidden APs, a WiFi sniffer device (e.g., WiFi scanning device) can utilize various techniques. For example, in the one or more WiFi scans performed by the device, passive scanning can be performed for hidden APs based on detecting a beacon frame with a null or empty SSID field. A beacon frame without a value in the SSID field can indicate the presence of a hidden WiFi AP, although the beacon frame alone may not be indicative of further information relating to the hidden AP and/or network.

In some examples, the WiFi sniffer can transmit one or more probe request frames during a WiFi scan (e.g., also referred to as a WiFi collection or WiFi collection instance) performed by the WiFi sniffer device. The probe request frames can be used to trigger APs within range (e.g., APs that receive the probe request frame(s) transmitted by the WiFi sniffer device) to provide a response. The probe request frame may identify one or more APs or SSIDs for which a response is requested, or the probe request may be transmitted with an empty or null SSID field to thereby prompt all APs within range to respond (e.g., including any hidden APs within range). The responses received can be indicative of the MAC address of each hidden AP that is present and responds to the request.

WiFi sniffers and the collected WiFi scans may additionally capture packets and WiFi data frames to and from the connected clients associated with a given AP or WiFi network (e.g., packets and WiFi data frames transmitted between a connected client and an AP). In some examples, the presence of a hidden AP can be detected based on collecting and analyzing the data frames between connected clients and the AP. For instance, traffic pattern analysis performed based on the collected data frames (and the various MAC addresses within) can be used to reveal or otherwise determine the existence of a hidden AP within range of the WiFi sniffer device used to perform the WiFi scan or collection.

Further aspects of the systems and techniques will be described with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

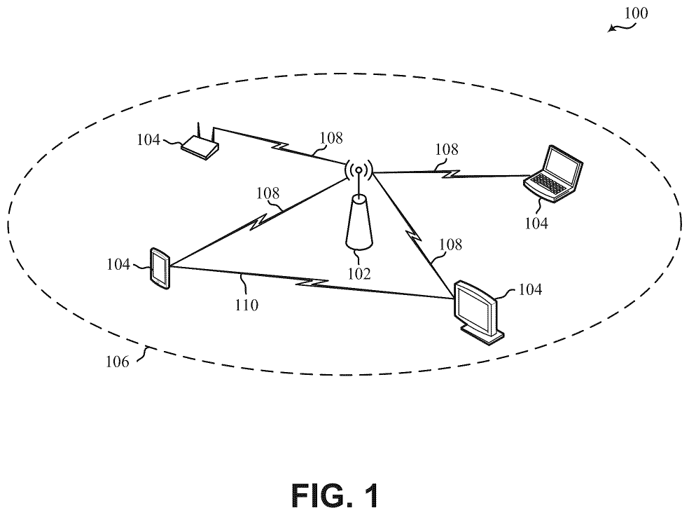

FIG. 1 is a block diagram illustrating an example wireless communication network 100. In some aspects, the wireless communication network 100 can be an example of a wireless local area network (WLAN). As used herein, a WLAN may also be referred to as a Wi-Fi network. In some examples, the WLAN 100 can be a network implementing at least one of the IEEE 802.11 family of wireless communication protocol standards (e.g., such as that defined by the IEEE 802.11-2016 specification or amendments thereof including, but not limited to, 802.11ay, 802.11ax, 802.11az, 802.11ba and 802.11be). The WLAN 100 may include at least one access point (AP) 102 and multiple associated stations (STAs) 104. While only one AP 102 is shown, the WLAN network 100 also can include multiple APs 102.

Each of the STAs 104 also may be referred to as a mobile station (MS), a mobile device, a mobile handset, a wireless handset, an access terminal (AT), a user equipment (UE), a subscriber station (SS), and/or a subscriber unit, among other examples. The STAs 104 may represent various devices such as mobile phones, personal digital assistant (PDAs), other handheld devices, netbooks, notebook computers, tablet computers, laptops, display devices (e.g., TVs, computer monitors, navigation systems, etc.), music or other audio or stereo devices, remote control devices (“remotes”), printers, kitchen or other household appliances, key fobs (e.g., for passive keyless entry and start (PKES) systems), etc.

A single AP 102 and an associated set of STAs 104 may be referred to as a basic service set (BSS), which is managed by the respective AP 102. FIG. 1 additionally shows an example coverage area 106 of the AP 102, which may represent a basic service area (BSA) of the WLAN 100. The BSS may be identified to users by a service set identifier (SSID), as well as to other devices by a basic service set identifier (BSSID), which may be a medium access control (MAC) address of the AP 102. An extended service set identified (ESSID) can refer to a collection of APs that share the same SSID.

The AP 102 periodically broadcasts beacon frames (“beacons”) including the BSSID to enable any STAs 104 within wireless range of the AP 102 to “associate” or re-associate with the AP 102 to establish a respective communication link 108 (e.g., hereinafter also referred to as a “Wi-Fi link”). STAs 104 may additionally use the beacon frames broadcast by AP 102 to maintain a communication link 108 with the AP 102. For example, the beacons can include an identification of a primary channel used by the respective AP 102 as well as a timing synchronization function for establishing or maintaining timing synchronization with the AP 102. The AP 102 may provide access to external networks to various STAs 104 in the WLAN via respective communication links 108.

To establish a communication link 108 with an AP 102, each of the STAs 104 can perform passive or active scanning operations (“scans”) on frequency channels in one or more frequency bands (e.g., the 2.4 GHz, 5 GHz, 6 GHz, or 60 GHz bands). For example, to perform passive scanning, a STA 104 listens for beacons that are transmitted by respective APs 102 at a periodic time interval referred to as the target beacon transmission time (TBTT). The TBTT can be measured in time units (TUs). In some examples, one TU may be equal to 1024 microseconds (μs). To perform active scanning, a STA 104 generates and sequentially transmits probe requests on each channel to be scanned and listens for probe responses from APs 102. Each STA 104 may be configured to identify or select an AP 102 with which to associate (e.g., based on the scanning information obtained through the passive or active scans), and to perform authentication and association operations to establish a communication link 108 with the selected AP 102. The AP 102 assigns an association identifier (AID) to the STA 104 at the culmination of the association operations, which the AP 102 uses to track the STA 104.

In some cases, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. In some examples, a STA 104 can be covered by more than one AP 102 and can associate with different APs 102 at different times for different transmissions. After association with an AP 102, a STA 104 also may be configured to periodically scan its surroundings to find a more suitable AP 102 with which to associate. For example, a STA 104 that is moving relative to its associated AP 102 may perform a “roaming” scan to find another AP 102 having more desirable network characteristics (e.g., such as a greater received signal strength indicator (RSSI), a reduced traffic load, etc.).

In some cases, STAs 104 may form networks without APs 102 or other equipment other than the STAs 104 themselves. One example of such a network is an ad hoc network (e.g., or wireless ad hoc network). Ad hoc networks may alternatively be referred to as mesh networks or peer-to-peer (P2P) networks. In some cases, ad hoc networks may be implemented within a larger wireless network (e.g., such as WLAN 100). In such implementations, while the STAs 104 may be capable of communicating with each other through the AP 102 using communication links 108, the STAs 104 may also communicate directly with each other (e.g., with other STAs 104) using direct wireless links 110. In some examples, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless links 110 can include one or more (or all) of Wi-Fi Direct connections, connections established by using a Wi-Fi Tunneled Direct Link Setup (TDLS) link, and other P2P group connections, etc.

The APs 102 and STAs 104 may function and communicate (e.g., using the respective communication links 108) according to the IEEE 802.11 family of wireless communication protocol standards (e.g., such as that defined by the IEEE 802.11-2016 specification or amendments thereof including, but not limited to, 802.11ay, 802.11ax, 802.11az, 802.11ba and 802.11be). These standards define the WLAN radio and baseband protocols for the physical (PHY) and medium access control (MAC) layers. For example, the APs 102 and STAs 104 transmit and receive wireless communications (e.g., hereinafter also referred to as “Wi-Fi communications”) to and from one another in the form of PHY protocol data units (PPDUs) (or physical layer convergence protocol (PLCP) PDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some implementations of the APs 102 and STAs 104 described herein also may communicate in other frequency bands, such as the 6 GHz band, which may support both licensed and unlicensed communications. The APs 102 and STAs 104 also can be configured to communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax, and 802.11be standard amendments may be transmitted over the 2.4, 5 GHz or 6 GHz bands, each of which is divided into multiple 20 MHz channels. As such, these PPDUs are transmitted over a physical channel having a minimum bandwidth of 20 MHz. In some cases, larger bandwidth channels can be formed through channel bonding. For example, PPDUs may be transmitted over physical channels having bandwidths of 40 MHz, 80 MHz, 160 or CCC20 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

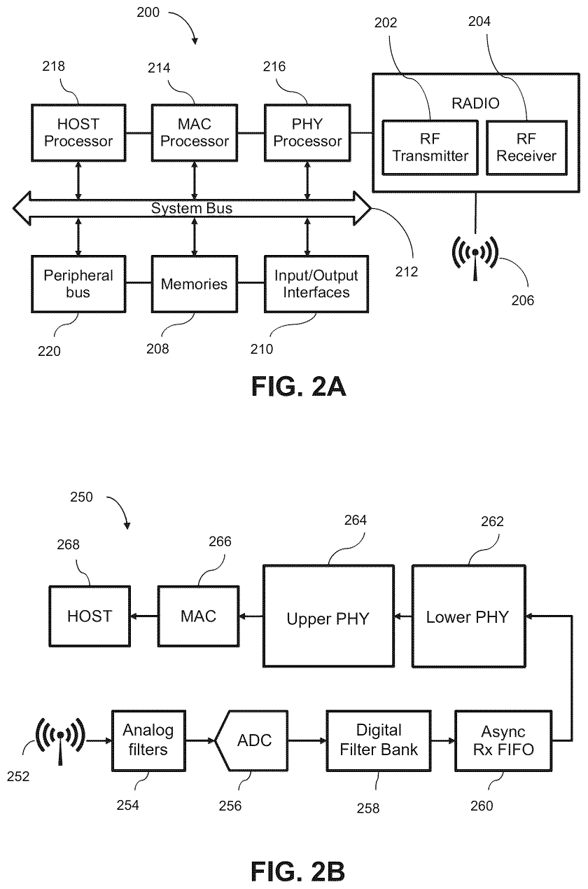

FIG. 2A is a high-level block diagram of an exemplary wireless communication device 200 that can be used to implement a STA or an AP, in some examples. The wireless communication device 200 can include a MAC layer and a PHY layer in accordance with one or more of the IEEE 802.11 standards.

The wireless communication device 200 includes a Radio Frequency (RF) transmitter module 202, an RF receiver module 204, an antenna unit 206, one or more memory banks 208, input and output interfaces 210, and communication bus 212. The RF transmitter module 202 and the RF receiver module 204 include a modem (modulator-demodulator device), which transmits data by modulating one or more carrier wave signals to encode digital information, as well as receives data by demodulating the signal to recreate the original digital information. As illustrated, the wireless communication device 200 further includes a MAC processor 214, a PHY processor 216 and a HOST processor 218. These processors can be any type of Integrated Circuit (IC) including a general processing unit, an Application Specific Integrated Circuit (ASIC) or Reduced Instruction Set Computer-Five (RISC-V) based ICs, amongst others.

The memory 208 can be used to store software and/or computer-readable instructions, including software or instructions that can be used to implement at least some functions of the MAC layer. For example, each processor included in the wireless communication device 200 (e.g., MAC processor 214, PHY processor 216, HOST processor 218, etc.) executes respective software to implement the functions of the respective communication/application layer.

The PHY processor 216 includes a transmitting signal processing unit and a receiving signal processing unit (not shown) and can be used to manage the interface with the Wireless Medium (WM). The PHY processor 216 operates on PPDUs by exchanging digital samples with the radio module which includes the RF transmitter 202, the RF receiver 204, analog-to-digital converters, and digital filters.

The MAC processor 214 executes MAC level instructions and manages the interface between the application software and the WM, through the PHY processor 216. The MAC processor 214 is responsible for coordinating access to the WM so that the Access Point (AP) and STAs in range can communicate effectively. The MAC processor 214 adds header and tail bytes to units of data provided by the higher levels and sends them to the PHY layer for transmission. The reverse happens when receiving data from the PHY layer. If a frame is received in error, the MAC processor 214 manages the retransmission of the frame.

The HOST processor 218 interfaces with the MAC layer and is responsible for running higher level functionalities of the wireless communication device.

The PHY processor 216, the MAC processor 214, the HOST processor 218, the peripheral bus 220, the memories 208, and the input/output interfaces 210 communicate with each other via the peripheral bus 212. The peripheral bus 220 connects to a number of peripherals that support core functions of the wireless communication device 200, including timers, interrupts, radio/filters/system registers, counters, UART, GPIO interfaces, among others. The memory 208 may further store an operating system and applications. In some examples, the memory may store recorded information about captured frames and packets. The input/output interface unit 210 allows for exchange of information with a user of the wireless communication device. The antenna unit 206 can include a single antenna and/or can include or multiple antennas. For example, multiple antennas can be used to implement Multiple Input Multiple Output (MIMO) techniques, among others.

FIG. 2B illustrates a schematic block diagram of a receiver data flow architecture 250 that can be used to receive Wi-Fi packets over the network. In one illustrative example, the receiver data flow architecture 250 illustrated in FIG. 2B can correspond to or otherwise be associated with the wireless communication device 200 illustrated in FIG. 2A. Radio signals are received over the WM and translated into electrical signals by the receiving antenna 252 (e.g., which can be the same as or similar to antenna 206). The received signal is conditioned using a series of analog filters 254 (e.g., depicted as analog RF receive (Rx) filters) before being converted into a digital signal equivalent using an Analog-to-Digital Converter (ADC) 256. The sampled signal output of ADC 256 is conditioned again using a filter bank 258, which can include one or more digital RF filters and/or a farrow, before the samples are collected in an asynchronous receiving First-In-First-Out (FIFO) data structure 260.

Samples in FIFO structure 260 can be accessed by a plurality of modules. For example, samples can be accessed by a packet detect module and a sub-band module, both of which may be included in the lower-level PHY portion 262 depicted in FIG. 2B. In some embodiments, the lower-level PHY portion 262 is itself included in the PHY processor 216 illustrated in FIG. 2A.

The packet detect module included in the lower-level PHY portion 262 can include hardware and/or implement algorithms that can be used to analyze the initial sections of the PPDU in the time domain. Based on the analysis, the packet detect module can be used to recognize a received frame and synchronize frequency and timing of the wireless communication device with the packet being received. The sub-band module included in the lower-level PHY portion 262 can include hardware and/or implement algorithms that can be used to detect which subchannel in the allocated frequency band is being used for the packet being received.

Once a packet is detected and the relevant subchannel is established, samples can be forwarded to an upper-level PHY portion 264. The upper-level PHY portion 264 can be included in the PHY processor 216 illustrated in FIG. 2A. In some aspects, upper-level PHY portion 264 can be used to process and decode Orthogonal Division Multiplexing (OFDM) symbols (e.g., with the support of a coprocessor module) to reconstruct the full PPDU. The reconstructed PPDU is output by the upper-level PHY portion 264 and subsequently processed by the MAC layer processor 266. The MAC layer processor 266 can be used to extract the data payload from the PPDU and provide the relevant information to the HOST layer 268 for consumption.

In some examples, the MAC layer processor 266 illustrated in FIG. 2B can be the same as or similar to the MAC processor 214 illustrated in FIG. 2A. In some cases, the HOST layer 268 illustrated in FIG. 2B can include or otherwise can be the same as or similar to the HOST processor 218 illustrated in FIG. 2A.

As noted previously, systems and techniques are described herein for performing WiFi scanning and/or WiFi collection (e.g., also referred to as WiFi sniffing). In particular, a handheld WiFi scanning apparatus is provided, which can include an external optic (e.g., such as a monocular or spotting scope) and a directional antenna that can be used to perform more accurate, granular, and/or focused WiFi scanning and collection. In one illustrative example, the disclosed WiFi scanning apparatus can be used to perform WiFi scanning, surveying, collection, etc. (e.g., WiFi sniffing) and may additionally be used to perform Bluetooth scanning, surveying, collection, etc. (e.g., Bluetooth sniffing), including for Bluetooth Low Energy (BLE) transmissions and packets. In other words, the WiFi scanning apparatus described herein can be used to perform WiFi scanning based on the collection of WiFi packets, can be used to perform Bluetooth/BLE scanning based on the collection of BLE packets, or can be used to perform various combinations thereof of both WiFi and Bluetooth/BLE scanning and packet collection.

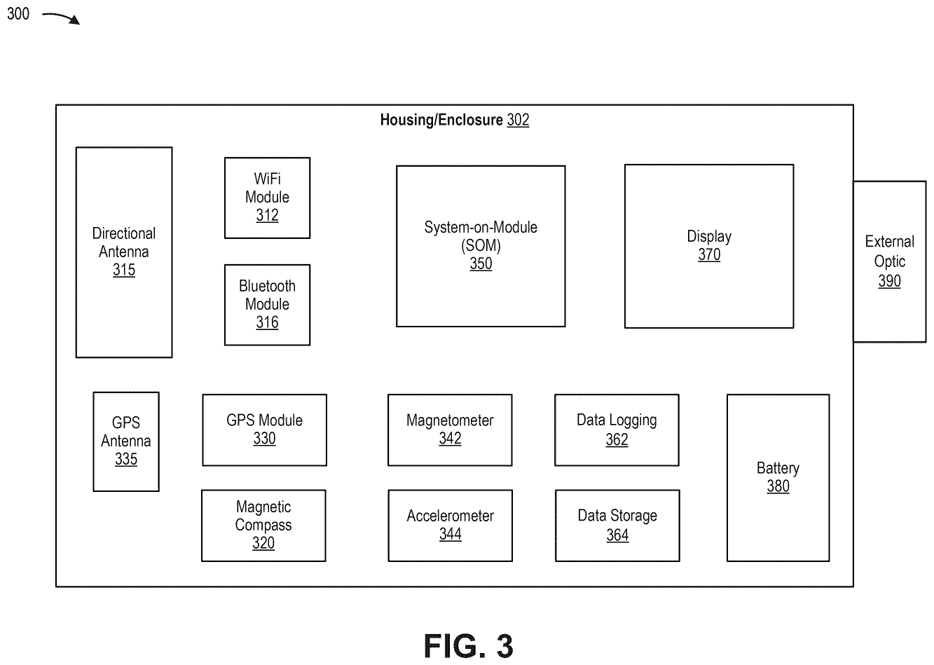

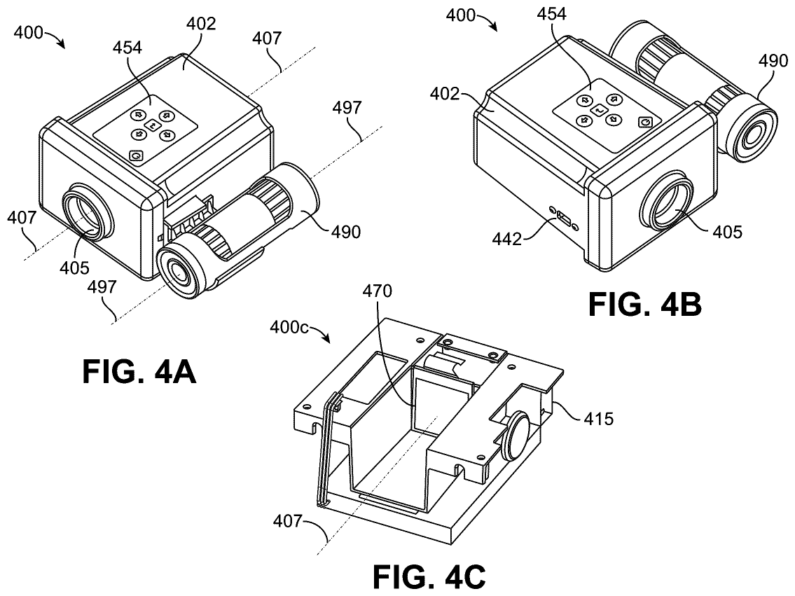

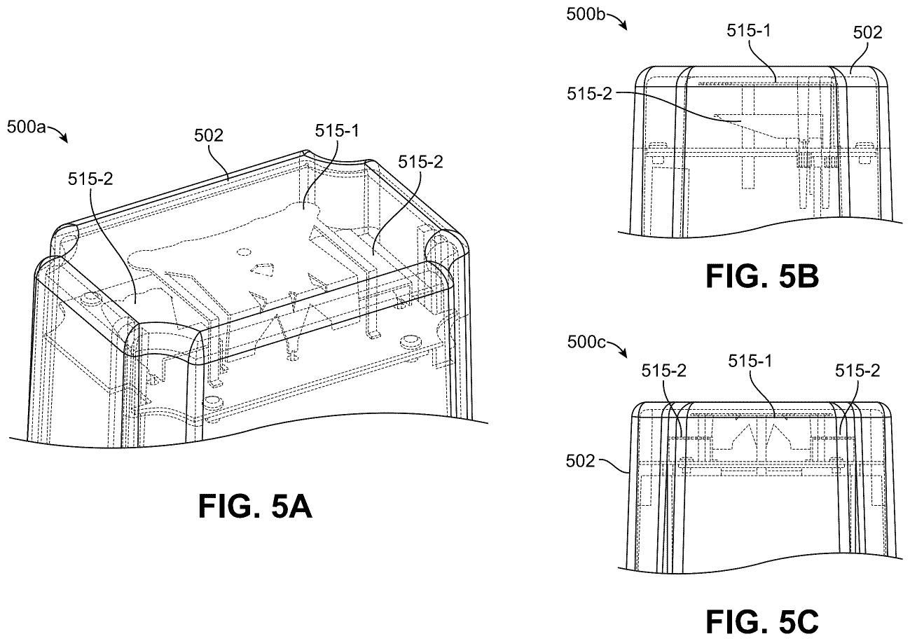

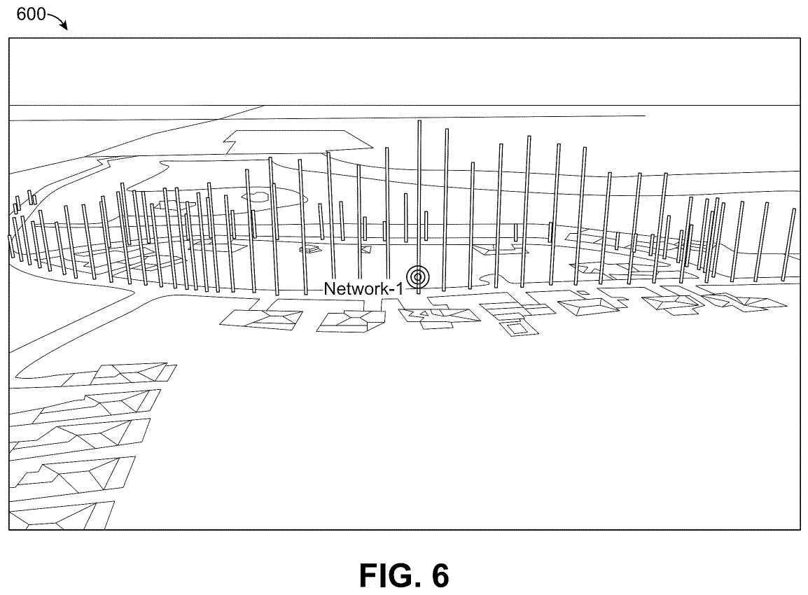

FIG. 3 is a block diagram illustrating an example architecture of a handheld WiFi scanning apparatus according to aspects of the present disclosure. FIGS. 4A-4C illustrate various perspective views of an example handheld WiFi scanning apparatus, which may be implemented using an architecture the same as or similar to that shown in FIG. 3. FIGS. 5A-5C illustrate various perspective views of an example directional antenna that can be used for WiFi and/or Bluetooth scanning and packet collection by the disclosed WiFi scanning apparatus. FIGS. 6-10 are diagrams illustrating various examples of WiFi scans and WiFi scan locations that may be associated with WiFi packet collection or WiFi sniffing performed using the disclosed WiFi scanning apparatus of FIGS. 3-5C and/or otherwise described and disclosed herein.

In some embodiments, the WiFi scanning apparatus described herein (e.g., the WiFi scanning apparatus of FIGS. 3-5C, etc.) can be used to perform WiFi and/or Bluetooth/BLE scans, where the collected WiFi or Bluetooth packets are combined with per-packet information (PPI) for geolocation. For example, collected packets can be correlated and stored in combination with PPI geolocation information that is determined using one or more location or positioning systems included within the WiFi scanning apparatus. Each collected packet can be associated with location or position information that was determined by the WiFi scanning apparatus at the same time as the respective packet was collected (e.g., such that the PPI geolocation information represents the location, position, orientation, etc., of the WiFi scanning apparatus at the moment in time when each respective packet of a plurality of collected WiFi or Bluetooth packets was obtained by the WiFi scanning apparatus).

In some aspects, the WiFi scanning apparatus can be configured to collect and store a plurality of packets corresponding to a particular WiFi or Bluetooth scan that is performed by a user of the WiFi scanning apparatus (e.g., using the WiFi scanning apparatus). In some embodiments, the stored packets can include geolocation and/or positioning information corresponding to the time of collection for each stored packet of a given scan. In some aspects, the geolocation and/or positioning information may comprise, or otherwise include, PPI geolocation information implemented according to the Per-Packet Information (PPI) standard. For example, the collected packets for each scan performed with the WiFi scanning apparatus may be stored using one or more packet capture (PCAP) data files. Each PCAP data file can include packet data of the scan, along with information associated with performing the scan. In some embodiments, the PPI geolocation information can comprise GPS geolocation information and vector-based orientation or heading information from the WiFi scanning apparatus. The PPI-based GPS geolocation and vector orientation information can be embedded in the PCAP data files for the WiFi or Bluetooth scans performed using the WiFi scanning apparatus. In some aspects, the PPI information may additionally, or alternatively, include or otherwise be indicative of altitude information of the WiFi scanning apparatus at the time a respective packet was collected, angle of attack information of the WiFi scanning apparatus associated with collecting the respective packet, etc. Further details of the geolocation information and/or PPI-based information that may be combined or embedded within the PCAP data files generated by the WiFi scanning apparatus will be described below with respect to FIGS. 3-10.

In one illustrative example, the presently disclosed WiFi scanning apparatus can be provided as a handheld and portable computing device. For example, the WiFi scanning apparatus can be a handheld and portable computing device running Linux or a Linux-based operating system (OS) that can support various user configuration operations and options, as well as various user input and interaction operations and options (as will be described in greater detail below).

The disclosure turns now to FIGS. 3 and 4A-4C. FIG. 3 is a block diagram illustrating an example architecture of a handheld WiFi scanning apparatus 300, and FIGS. 4A-4C illustrate perspective views of an example handheld WiFi scanning apparatus that may be the same as or similar to the WiFi scanning apparatus 300 of FIG. 3.

The handheld WiFi scanning apparatus 300 can include a housing (e.g., enclosure) 302 and a plurality of components located within the housing 302. For example, the various components shown within the housing 302 in the architecture diagram of FIG. 3 can be located within an enclosed interior volume of the housing 302 provided for or by the handheld WiFi scanning apparatus 300. In some aspects, the handheld WiFi scanning apparatus 300 of FIG. 3 may be the same as or similar to the example WiFi scanning apparatus 400a in the perspective view of FIG. 4A, may be the same as or similar to the example WiFi scanning apparatus 400b of the perspective view of FIG. 4B, and/or may be the same as or similar to the example WiFi scanning apparatus associated with the view 400c of FIG. 4C. For example, the housing 302 of FIG. 3 can be the same as or similar to the housing 402 of FIGS. 4A and 4B.

In some embodiments, the housing 302 can be provided as a standalone plastic enclosure that is sealed against the external or surrounding environment of the WiFi scanning apparatus 300. For example, the enclosed interior volume of the housing 302 can be sealed for weatherproofing and protection of the internal components of the WiFi scanning apparatus 300 from water ingress, etc.

On the exterior or outer surface of the housing 302, a mechanical connection or coupling can be provided to attach an external optic 390. The external optic 390 can be utilized (e.g., by a user of the WiFi scanning apparatus 300) to more accurately and/or precisely align, orient, and/or position the WiFi scanning apparatus 300 to perform a WiFi scan and packet collection within a specific area or angular range in front of the WiFi scanning apparatus 300. In some embodiments, the external optic 390 can comprise a monocular or spotting scope that has an optical axis aligned with the collection direction configured for the WiFi scanning apparatus 300 (e.g., where the collection direction or scan direction of the WiFi scanning apparatus 300 is based on the use of a directional antenna 315 provided within the housing 302).

For instance, the external optic 390 of FIG. 3 can be the same as or similar to the external optic 490 shown in FIGS. 4A and 4B as coupled to the side of the housing 402 of the WiFi scanning apparatus 400. In particular, FIGS. 4A and 4B illustrate an example configuration where the external optic 390/490 comprises a monocular or a spotting scope. The longitudinal axis of the external optic 490 can be the same as or otherwise parallel to the optical axis of the external optic 490. For example, the optical and longitudinal axis of the external optic 490 runs from the bottom left to the top right in the view of FIG. 4A, and from the bottom right to the top left in the example view of FIG. 4B.

The external optic 490 (also referred to interchangeably herein as monocular 490 or scope 490) can be permanently, semi-permanently, or detachably coupled to the exterior surface or sidewall of the housing 402 of the WiFi scanning apparatus 400. For example, a mounting bracket or coupling sleeve (among various other mechanical means) can be used to secure the scope 490 to the housing 402 of the WiFi scanning apparatus 400, such that the longitudinal/optical axis of the scope 490 is aligned with the longitudinal axis of the WiFi scanning apparatus 400. For example, the longitudinal/optical axis of the scope 490 is shown in FIG. 4A as the axis 497 and the longitudinal axis of the WiFi scanning apparatus 400 is shown in FIG. 4A as the axis 407, which is substantially parallel to the optical axis 497 of the scope 490.

In operation, the user of the WiFi scanning apparatus 400 of FIGS. 4A and 4B (and/or the WiFi scanning apparatus 300 of FIG. 3) may align, orient, or otherwise position the WiFi scanning apparatus 400 based on a magnified view through the attached scope 490. Based on the optical axis 497 being parallel to the longitudinal axis 407 of the WiFi scanning apparatus 400, the field of view imaged through the attached scope 490 can be the same as, similar to, and/or can correspond to the area or angular range over which the directional antenna of the WiFi scanning apparatus 400 is configured to perform the WiFi scan and packet collection operations.

For example, the directional antenna 315 shown in the WiFi scanning apparatus architecture 300 of FIG. 3 (e.g., which may be the same as or similar to the directional antenna 415 shown partially visible in FIG. 4C, and/or which may be the same as or similar to the directional antenna 515-1 and/or 515-2 shown in the various views of FIGS. 5A-5C) can have a directional sensitivity pattern such that the maximum gain or sensitivity of the directional antenna lies along the longitudinal axis 407 of the WiFi scanning apparatus 400.

As shown in the example architecture of FIG. 3, the WiFi scanning apparatus 300 can include a WiFi module 312 (e.g., a WiFi chipset or WiFi RF module) and a Bluetooth module 316 (e.g., a Bluetooth chipset or Bluetooth RF module), which can be associated with and utilize the directional antenna 315 to perform respective transmission and reception of WiFi or Bluetooth packets. In some aspects, the directional antenna 315 can combine one or more antennas configured for transmitting and/or receiving WiFi RF signals (e.g., associated with the WiFi module 312) and one or more antennas configured for transmitting and/or receiving Bluetooth or BLE RF signals (e.g., associated with the Bluetooth module 316). In some aspects, the WiFi scanning apparatus can search for, scan, and/or collect packets or other signal transmissions associated with non-standard WiFi networks and/or non-standard WiFi implementations. For example, non-standard WiFi networks and/or non-standard WiFi implementations can refer to WiFi communications that are performed outside of commercially-reserved WiFi channels and frequencies (e.g., outside of the WiFi channels and/or frequencies specified by the WiFi standard(s) and/or by relevant regulatory agencies, etc.). In some embodiments, the WiFi scanning apparatus 300 can additionally, or alternatively, include one or more radios, RF transceivers, and/or RF modules, etc., that can be configured to search for or scan for packets of interest within specified frequencies. For example, the scanning apparatus 300 can additionally, or alternatively, include one or more radios or RF transceivers/modules that can be configured and used to scan for packets on frequencies outside of the WiFi and/or Bluetooth frequencies. In some aspects, the scanning apparatus 300 can include or otherwise implement one or more software-defined radios (SDRs), which may be used to search for or scan on configured frequencies that may be the same as (either partially or wholly) one or more of the WiFi frequency ranges or the Bluetooth frequency ranges, etc. In some examples, the one or more SDRs may be used to search or scan on configured frequencies that are different from, and/or non-overlapping with the WiFi frequency ranges and/or the Bluetooth frequency ranges. In some embodiments, the WiFi module 312 and/or the Bluetooth module 316 can be implemented based on the WiFi scanning apparatus 300 (e.g., using the SOM 350, etc.) configuring one or more SDRs to perform scans within the WiFi frequency ranges and/or to perform scans within the Bluetooth frequency ranges, respectively.

For example, the WiFi module 312 can be connected to one or more WiFi antenna ports of the directional antenna 315, and the Bluetooth module 316 can be connected to one or more Bluetooth antenna ports of the directional antenna 315. In some embodiments, the directional antenna 315 can include two dual-band WiFi antenna ports, such as a 2.4 GHz WiFi antenna port and a 5 GHz WiFi antenna port (both of which can be coupled to the WiFi module 312, which can be selected to provide dual-band WiFi support or operations). The 2.4 GHz WiFi antenna port and the 5 GHz WiFi antenna port of the directional antenna 315 can be used to communicatively couple the WiFi module 312 to the corresponding portion(s) of the directional antenna 315, for transmitting, receiving, collecting, etc., one or more WiFi packets, transmissions, signals, etc. In some examples, the WiFi module 312 can include or otherwise utilize one or more U.FL antenna ports for connecting to the corresponding one or more WiFi antenna ports of the directional antenna 315. The one or more U.FL antenna ports for the WiFi module 312 can be surface-mount connections that can be used to connect the directional antenna 315 to the printed circuit board (PCB) or substrate of the WiFi module 312 chipset.

In some examples, the directional antenna 315 can include at least one 2.4 GHz Bluetooth antenna port, which can be separate from the 2.4 GHz WiFi antenna port. The 2.4 GHz Bluetooth antenna port of the directional antenna 315 can be used to communicatively couple the Bluetooth module 316 to the corresponding portion of the directional antenna 315, for transmitting, receiving, collecting, etc., one or more Bluetooth/BLE packets, transmissions, signals, etc. In some aspects, the Bluetooth module 316 can be used (in combination with the directional antenna 315 and/or a Bluetooth antenna port or antenna portion of the directional antenna 315) to perform transmission, reception, or both transmission and reception of various Bluetooth and/or BLE packets and signals. In some cases, the Bluetooth module 316 and directional antenna 315 can be used to perform packet collection of Bluetooth signals over a range of 300 meters or greater. In some cases, the Bluetooth packet collection range may be 340 meter or greater, although it is noted various other ranges and range values can also be utilized without departing from the scope of the present disclosure.

In some embodiments, the WiFi module 312 can support and/or implement dual-band 802.11ac/b/g/n WiFi communications. In one illustrative example, the WiFi module 312 and corresponding WiFi antennas of the directional antenna 315 can utilize a 2×2 configuration of transmitters and receivers (e.g., also referred to as 2T2R, or 2Tx-2Rx). In some aspects, a first transmitter of the 2×2 configuration can correspond to 2.4 GHz WiFi Tx operations and a second transmitter of the 2×2 configuration can correspond to 5 GHz WiFi Tx operations. Similarly, a first receiver of the 2×2 configuration can correspond to 2.4 GHz WiFi Rx operations, and a second receiver of the 2×2 configuration can correspond to 5 GHz WiFi Rx operations. In some aspects, the WiFi scanning apparatus 300 can further include one or more cellular communication modules, components, radios, antennas, etc., that can be used to provide wireless communications over a cellular network between the WiFi scanning apparatus 300 and a remote user and/or remote server or other computing device associated with the WiFi scanning apparatus 300. For example, the WiFi scanning apparatus 300 can include cellular connectivity for wireless communications on a public or private cellular network, including but not limited to 4G LTE cellular networks, 5G NR cellular networks, and beyond. In some cases, the WiFi scanning apparatus 300 can use the wireless cellular network connectivity to transmit uplink data to the remote user or server, where the transmitted uplink data corresponds to one or more WiFi collections, surveys, or scans and/or includes some or all of the WiFi packets that were collected by the WiFi scanning apparatus 300. In some examples, the WiFi scanning apparatus 300 can use the wireless cellular network connectivity to receive downlink data or information from the remote user or server, where the received downlink data or information corresponds to user inputs, configurations, controls, commands, etc., associated with triggering, starting, stopping, performing, adjusting, etc., one or more WiFi scans by the WiFi scanning apparatus 300.

The WiFi module 312 can include one or more USB interfaces for connection to a host, for receiving configuration information, etc. In some examples, the WiFi module 312 can be connected to a system-on-module (SOM) 350 included in the WiFi scanning apparatus 300. The SOM 350 can combine a microprocessor or microcontroller, memory (RAM, flash storage, etc.), and various other processing and control circuitry into a single package. For example, the SOM 350 can provide the core computing engine or computational and processing capabilities for the WiFi scanning apparatus 300. In some cases, the SOM 350 may include an integrated WiFi module that is separate from the discrete WiFi module 312 of the WiFi scanning apparatus 300. The SOM 350 may additionally include an integrated Bluetooth/BLE module (or other configurable RF transceivers, etc.) that is separate from the discrete Bluetooth/BLE module 314 of the WiFi scanning apparatus 300. The SOM 350 can additionally implement various input/output (I/O) interfaces for providing connectivity between the WiFi scanning apparatus 300 and various external devices or peripherals (e.g., I/O interfaces such as USB, SPI, UART, etc.).

In some aspects, the SOM 350 can include an integrated WiFi and/or other RF communications modules, radios, transceivers, antennas, etc., that can be used to create a wireless hotspot for communications between the WiFi scanning apparatus 300 and an external computing device (e.g., user computing device, smartphone, etc.). For example, the SOM 350 can include an integrated WiFi module that can be used to create a WiFi hotspot that allows data files, WiFi scan results or collections, etc., to be transferred onto (e.g., transmitted to) and off of (e.g., received from) the WiFi scanning apparatus 300, for instance using HTTP or SSH over the WiFi network of the WiFi hotspot implemented by the SOM 350 and/or WiFi scanning apparatus 300.

The SOM 350 can further include power management circuitry for managing and controlling power to the WiFi scanning apparatus 300 and its constituent components, from one or more batteries 380 included within the housing 302. For example, the battery 380 can be an internal, rechargeable battery within the housing 302, with power management and charging functionalities associated with the battery 380 controlled or managed by the SOM 350. In some aspects, the battery 380 can be sized to support 8 hours of runtime or operation of the WiFi scanning apparatus 300 and its various components, although it is noted that various different capacities and/or runtimes may also be configured for the battery 380 and the WiFi scanning apparatus 300 without departing from the scope of the present disclosure.

The SOM 350 can, in some aspects, be included in the WiFi scanning apparatus 300 and used to provide the core components of an embedded processing system (e.g., processor cores, communication interfaces, memory blocks, etc.) in a single package (i.e., on a single PCB). The SOM 350 can therefore be designed or used for embedding into an end system, such as the presently disclosed WiFi scanning apparatus 300.

In some examples, the SOM 350 can run Linux or a Linux-based operating system (OS) that can support various user configuration operations and options, as well as various user input and interaction operations and options. In some examples, the SOM 350 can be configured to run OpenWRT (e.g., a Linux-based firmware for network routers and embedded devices) or a similar operating system suitable for providing an embedded Linux-based operating system for routing, managing, or interacting with network traffic.

In one illustrative example, the WiFi scanning apparatus 300 can be used to perform WiFi sniffing (e.g., WiFi scanning, collection, etc.) utilizing at least the SOM 350, the WiFi module 312, and the directional antenna 315. As noted previously, to capture packets, a WiFi sniffer can utilize a monitoring mode that allows the device to capture or otherwise obtain all wireless traffic that is within range, across multiple channels (e.g., including the packets and wireless traffic that are not directed or addressed specifically to the WiFi sniffer device). In the monitoring mode, the WiFi sniffer device is not necessarily associated with a particular wireless access point (AP), and is instead configured to capture packets to or from any AP and WiFi network that is within range (e.g., that can be detected and received using one or more antennas, radios, WiFi receivers, etc., included in or otherwise implemented by the WiFi sniffer device).

Accordingly, the WiFi module 312 of the WiFi scanning apparatus 300 can be selected as a WiFi module (or chipset) that supports monitor mode and packet injection, on both the 2.4 GHz and 5 GHz bands commonly utilized by WiFi networks. In some embodiments, the WiFi sniffing or WiFi scanning operations performed by a user of the WiFi scanning apparatus 300 can be configured and/or controlled at least in part by the SOM 350. For example, the housing 302 can include a USB port or connector (e.g., USB-C, etc.), or various other data connectors, ports, or interfaces, which may be utilized to provide both charging of the internal battery 380 of the WiFi scanning apparatus 300, as well as to provide data connection between the processor(s) of the SOM 350 and an external host, computing device, user device, etc. The data connection to the processor(s) of the SOM 350 can be utilized to provide, adjust, and/or modify various user configurations of the WiFi scanning apparatus 300 and the various types or modes of WiFi sniffing or collections that may be performed with the WiFi scanning apparatus 300.

The data connection to the processor(s) of the SOM 350 can additionally be used to provide various user interactions with the WiFi scanning apparatus 300, using an external computer or computing device that is connected to the SOM 350/WiFi scanning apparatus 300 via the USB-C port or other data connection included in or on the housing 302.

As illustrated in the example architecture of FIG. 3, the WiFi scanning apparatus 300 can additionally include one or more positioning or location modules or engines, which can be used to determine precise location information of the WiFi scanning apparatus 300 during WiFi sniffing, scanning, or collection operations. For example, the WiFi scanning apparatus 300 can in one illustrative example include a GPS module 330 (e.g., GPS receiver, GPS chipset) that can be used to provide location information during WiFi packet collections by the WiFi scanning apparatus 300.

In some embodiments, the GPS module 330 can be associated with and utilize a dedicated GPS antenna 335, which may be provided within the enclosure 302, outside of the enclosure 302, and/or various combinations of inside and outside of the enclosure 302. In some examples, the GPS antenna 335 can be an internal, off-board antenna within the enclosure 302 (e.g., a dedicated GPS antenna that is separate from the directional antenna 315 and separate from the board, PCB, substrate, etc., of the GPS module 330 and the SOM 350).

The GPS module 350 can be configured to determine location or position information of the WiFi scanning apparatus 300 during collections, as noted previously above. The GPS module 350 can determine the location or position information using various overhead, satellite positioning system or constellations. For example, the GPS module 350 can use the GPS antenna 335 to receive positioning singles from one or multiple global navigation satellite systems (GNSS). In some embodiments, the GPS module 350 can use the GPS antenna 335 to perform positioning based on respective positioning signals received from the GPS satellite system, the Galileo satellite system, the GLONASS satellite system, and/or the BeiDou satellite system, among various others. In one illustrative example, the GPS module 350 can use the GPS antenna 335 to perform concurrent reception of up to three different GNSS satellite systems and the respective positioning signals thereof. For instance, concurrent reception can be performed from up to three GNSS satellite systems selected from GPS, Galileo, GLONASS, and BeiDou, etc.

The GPS module 350 can be coupled to a corresponding connector or I/O port of the SOM 350, and may be configured to implement advanced jamming and spoofing detection for improved accuracy and reliability of the location or positioning information determined using the GPS module 350 and positioning signals received via the GPS antenna 335. In some embodiments, the GPS module 350 can be configured to support various different satellite or GNSS augmentation systems that integrate external information or information sources (e.g., in addition to the GNSS positioning signals transmitted from the satellites themselves) to improve the precision, reliability, availability, etc., of the location information generated by the GPS module 350. For example, the GPS module 350 can utilize various different satellite-based augmentation systems (SBAS) that utilize additional satellite-broadcast messages in combination with the GNSS satellite positioning signals, and/or may utilize various different ground-based augmentation systems (GBAS) to implement differential GPS (DGPS) corrections, etc.

The WiFi scanning apparatus 300 can further include a magnetic compass 320 configure to obtain pointing vector heading orientation data during collection (e.g., WiFi/packet collections by the WiFi scanning apparatus 300). In some aspects, the pointing vector or heading orientation data obtained using the magnetic compass 320 can be aligned to provide a heading that corresponds to the heading of the longitudinal axis 407 of the WiFi scanning apparatus 400 (e.g., shown in FIG. 4A) and/or the heading of the optical axis 497 of the attached spotting scope or monocular 490 (e.g., also shown in FIG. 4A). Accordingly, the magnetic compass 320 can provide pointing vector heading orientation data indicative of where the WiFi scanning apparatus 300 is being pointed during WiFi or packet collections (e.g., based on the directional antenna 315/415 being configured with maximum or increased gain in the same direction as the longitudinal axis 407 and spotting scope optical axis 497).

In some embodiments, the GPS module 330 can be configured and/or controlled by the SOM 350 to provide position stamping of one or more WiFi or Bluetooth packets collected (e.g., received) by the directional antenna 315 during scanning operations of the WiFi scanning apparatus 300. For example, the GPS module 350 can provide position stamping with GPS location coordinates via (e.g., in response to) queries from the SOM 350. Similarly, the magnetic compass 320 can be configured and/or controlled by the SOM 350 to provide heading orientation or pointing vector information corresponding to the orientation of the WiFi scanning apparatus 300 during the collection of one or more WiFi or Bluetooth packets obtained using the directional antenna 315. The magnetic compass 320 can provide the heading orientation or pointing vector data via queries from the SOM 350.

In some aspects, SOM 350 can query both the GPS module 330 and the magnetic compass 320 simultaneously, or in parallel, to thereby obtain respective location information and heading orientation information for the WiFi scanning apparatus 300 during the collection of some (or all) of the plurality of WiFi/Bluetooth packets obtained by the directional antenna 315 during a WiFi scanning operation. For example, for each packet obtained via the directional antenna 315 (or each packet obtained within the same time window corresponding to a desired or configured periodicity of the PPI geolocation augmentation performed by the WiFi scanning apparatus 300), the SOM 350 can use the GPS module 330 and the magnetic compass 320 to stamp the collected packet(s) with the corresponding location and heading information provided by the GPS module 330 and the magnetic compass 320, respectively.

For example, the WiFi scanning apparatus 300 can be used to perform WiFi and/or Bluetooth/BLE scans, where the collected WiFi or Bluetooth packets are combined with per-packet information (PPI) for geolocation. The collected packets obtained or received using the directional antenna 315 can be automatically correlated and stored in combination with PPI geolocation information that is determined using the GPS module 330 and the magnetic compass 320.

In some embodiments, the SOM 350 can communicate with or otherwise utilize a data logging engine 362 to store the collected packets and embedded PPI metadata in a data storage system 364 (e.g., such as an SD card, flash memory storage, etc.) of the WiFi scanning apparatus 300. The data storage system 364 can be provided as removable storage that can be inserted within the housing 302 and removed for connection to a different, external computing device for analysis or visualization of the collected scan information (e.g., such as by providing the data storage system 364 using an insertable SD or microSD card, or other insertable memory/storage). In some examples, the data storage system, 364 can be provided as non-removable storage within the housing 302, with data offloading and/or visualization operations on an external computing device supported based on a data connection between a corresponding data connector (e.g., USB-C, etc.) on the housing 302 that connects the SOM 350 (and accordingly, the internal components of the WiFi scanning apparatus 300 that are also connected to and/or controlled by the SOM 350) to the external computing device.

During scanning or collection operations by the WiFi scanning apparatus 300, each collected packet can be associated with location or position information that was determined by the WiFi scanning apparatus (e.g., location information determined in response to a query from the SOM 350 to the GPS module 330; heading orientation or pointing vector data determined in response to a query from the SOM 350 to the magnetic compass 320) at the same time as the respective packet was collected, such that the PPI geolocation information represents the location, position, orientation, etc., of the WiFi scanning apparatus 330 at the moment in time when each respective packet of a plurality of collected WiFi or Bluetooth packets was obtained by the WiFi scanning apparatus 300.

In some aspects, the WiFi scanning apparatus 300 can be configured to collect and store a plurality of packets where the stored packets include geolocation and/or positioning information corresponding to the time of collection for each stored packet of a given scan. In some aspects, the geolocation and/or positioning information may comprise, or otherwise include, PPI geolocation information implemented according to the Per-Packet Information (PPI) standard. For example, the collected packets for each scan performed with the WiFi scanning apparatus 300 may be stored in the data storage system 364, and based on using the data logging engine 362, as one or more packet capture (PCAP) data files. Each PCAP data file can include packet data of the scan, along with information associated with performing the scan. In some embodiments, the PPI geolocation information can comprise GPS geolocation information and vector-based orientation or heading information from the WiFi scanning apparatus 300, as described above. The PPI-based GPS geolocation and vector orientation information can be embedded in the PCAP data files for the WiFi or Bluetooth scans performed using the WiFi scanning apparatus 300. In some aspects, the PPI information may additionally, or alternatively, include or otherwise be indicative of altitude information of the WiFi scanning apparatus 300 at the time a respective packet was collected, angle of attack information of the WiFi scanning apparatus 300 associated with collecting the respective packet, etc.

In some embodiments, the WiFi scanning apparatus 300 can further include a magnetometer 342 and an accelerometer 344, which can be used to collect additional sensor data that can be used to generate or augment the PPI geolocation metadata that is embedded or stored in combination with the collected WiFi or Bluetooth packets obtained during operation of the WiFi scanning apparatus 300. In some cases, the magnetometer 342 and the accelerometer 344 can be implemented within the housing 302 as separate, discrete sensor components. In other example, the magnetometer 342 and the accelerometer 344 can be implemented as a combined 3D accelerometer and 3D magnetometer (e.g., in a single sensor package coupled to the SOM 350, etc.).

For example, a 3D magnetometer 342 can provide three magnetic field channels (e.g., a respective channel for the x, y, and z dimensions) and a 3D accelerometer 344 can provide three acceleration channels (e.g., a respective channel for the x, y, and z dimensions). The accelerometer 344 can be a digital linear accelerometer. The magnetometer 342 and accelerometer 344 can provide various different power modes and/or sensor data resolutions, which can be configured by the SOM 350 to adjust or otherwise control the operation of the magnetometer 342 and accelerometer 344. In some cases, the magnetometer 342 and accelerometer 344 can be configured to provide free-fall or motion detection to the SOM 350 and/or for the WiFi scanning apparatus 300, and may additionally provide magnetic field detection, temperature measurements, etc. In some aspects, the magnetometer 342 and the accelerometer 344 may communicate with the SOM 350 via one or more corresponding I/O pins or ports of the SOM 350. For example, the magnetometer 342 and accelerometer 344 may be associated with a serial bus interface with various different bandwidths for communication of the respective sensor data to the SOM 350. In some examples, the magnetometer 342 and accelerometer 344 may be associated with an SPI serial standard interface.

Sensor data obtained by the magnetometer 342 and accelerometer 344 can be provided to the SOM 350, and may be used to adjust or control the operation of the WiFi scanning apparatus 300 and/or may be used to augment the PPI geolocation data embedded in the collected packets obtained via the directional antenna 315, as described previously above. In other examples, the sensor data from the magnetometer 342 and accelerometer 344 may additionally be used to implement a tilt-compensated compass, which can be separate from or can be combined with the pointing vector heading orientation information obtained using the magnetic compass 320. In some aspects, the magnetic compass 320 can be the same as (e.g., implemented using) a combination of the functionalities provided by the magnetometer 342 and the accelerometer 344.

As shown in FIG. 4A and FIG. 4B, the WiFi scanning apparatus 400 (e.g., which can be the same as or similar to the WiFi scanning apparatus 300 of FIG. 3) can include a viewing aperture 405 that is provided on the side of the enclosure 402 (e.g., the same as or similar to enclosure 302 of FIG. 3). The viewing aperture 405 can be centered about the longitudinal axis 407 of the WiFi scanning apparatus 400, where the longitudinal axis 407 is parallel to the optical or viewing axis 497 of the attached monocular or spotting scope 490.

In one illustrative example, the viewing aperture 405 can be configured to provide a user of the WiFi scanning apparatus 400 with a viewport to an internal display of the WiFi scanning apparatus 400, such as the internal display 470 depicted in FIG. 4C. In particular, FIG. 4C illustrates a perspective view 400c of an example internal display 470 that may be included within the enclosed volume of the housing 402 of the example handheld WiFi scanning apparatus 400 shown in FIGS. 4A and 4B, in accordance with some examples. In some aspects, the display 470 of FIG. 4C can be the same as or similar to the display 370 shown in the example architecture of the WiFi scanning apparatus 300 of FIG. 3. For example, the display 370/470 can be coupled to and driven by the SOM 350, and can display a user interface of the WiFi scanning apparatus 300 that is implemented and provided by the SOM 350.

As illustrated in FIG. 4C, the internal display 470 (viewable through the aperture 405 of FIGS. 4A and 4B) can be aligned with the longitudinal axis 407 of the WiFi scanning apparatus 400. In some embodiments, the internal display 470 can be bonded to an internal bracket that holds the display 470 in position within the enclosure 402 (e.g., bonded to an internal bracket that maintains the alignment of the display 470 with both the longitudinal axis 407 of the WiFi scanning apparatus 400, and the open, circular viewing area provided by the aperture 405). The internal bracket can additionally maintain the distance between the aperture 405 and the internal display 470, where the distance is measured along the longitudinal axis 407. In some aspects, the internal display 470 can be implemented using an in-plane switching thin-film transistor (IPS TFT) display that is powered by the internal battery 380 of FIG. 3 and driven by the SOM 350 of FIG. 3 to provide the user interface for the presently disclosed WiFi scanning apparatus 300/400. It is noted that various other display technologies may also be utilized without departing from the scope of the disclosure. In some examples, the internal display 470 can be an IPS TFT screen with a resolution of 240×240 pixels, although it is again noted that various other display technologies and display resolutions, aspect ratios, etc., may also be utilized without departing from the scope of the present disclosure.

The WiFi scanning apparatus 400 can include a user input panel 454 that is shown in the examples of FIGS. 4A and 4B as being provided on the top, outer surface of the enclosure 402 as a cluster of mechanically actuatable buttons. For instance, the user input panel 454 can be used to provide user inputs corresponding to different options or UI outputs presented to the user of the WiFi scanning apparatus 400 on internal display 470 viewed through the aperture 405. In some examples, the user input panel 454 can include a directional arrow pad (e.g., up button, down button, left button, right button), an enter or menu button (shown in FIG. 4A and 4B as located at the center of the four directional arrow buttons), a power button, etc. Various other configurations of the user inputs and buttons provided on the user input panel 454 may also be utilized. In some cases, the user input panel 454 can comprise mechanically actuated buttons or keys. In other examples, the user input panel 454 can include touch-sensitive buttons or keys that utilize capacitive-based sensing in addition to, or instead of, mechanical actuation or movement of the button or key on the user input panel 454 by the user.

In some examples, the user input panel 454 and corresponding user interface and UI options shown on the internal display 470 can be used for the user of WiFi scanning apparatus 400 to select between different pre-programmed routines or scan options configured for the WiFi scanning apparatus 400.

For example, the user interface of the WiFi scanning apparatus 400 can include a main menu GUI that allows the user to select (e.g., using the user input panel 454) between different scanning modes such as WiFi scanning or Bluetooth/BLE scanning, as well as a settings GUI that presents further configuration and configurable options to the user. Selection of a WiFi scan option can trigger the WiFi scanning apparatus 400 to begin performing a WiFi scan, or can cause the internal display 470 to output a WiFi scan GUI with configurable options or user input prompts for configuring the WiFi scan that is to be performed.

In some aspects, selection of the WiFi scan can cause the internal display 470 to render and output a default GUI corresponding to an ongoing WiFi scan performed by the WiFi scanning apparatus 400. For example, the ongoing WiFi scan GUI can be indicative of collected information determined by the WiFi scanning apparatus 400 based on the collected WiFi packets. The WiFi scan GUI may indicate the received signal strength indicator (RSSI) value, encryption type, channel number, SSID (if not hidden), etc., for each AP that is detected by the WiFi scan. The WiFi scan GUI can be configured to update continuously or to update periodically (e.g., every second, every three seconds, etc.) with the most current information of the WiFi scan being performed. The user input panel 454 can be used to pause/resume the scan, to end the scan, save the scan, adjust or modify the ongoing scan, etc.

In some aspects, the user input panel 454 can be used to pause the scan and scroll through a listing (e.g., shown on the internal display 470) of all APs that have been detected or otherwise identified in the course of performing the current WiFi scan. Pressing the ‘select’ or ‘enter’ button of the user input panel 454 while the cursor is highlighting a particular AP of the listing can trigger the internal display 470 to present additional details for that specific or particular AP of the selection. For example, an AP details GUI can be presented on the internal display 470, and can include more detailed information of the collected packets that were observed in association with the selected AP, etc. The AP details GUI can additionally be used to follow the AP, return to the WiFi scan GUI, return to the main menu GUI, etc. In some examples, scrolling back to the top of the screen can trigger the WiFi scanning apparatus 400 to resume performing the WiFi scan. In some examples, pressing the select button of the user input panel 454 while actively performing the WiFi scan can return to the main menu GUI.

A WiFi details GUI can be selected by the user and shown on the internal display 470, indicative of information associated with a particular AP detected during the WiFi scan. For example, the WiFi details GUI can include information such as the ESSID, BSSID, channel, encryption, etc., associated with the selected AP. In some cases, selection of a particular AP for viewing in the WiFi details GUI can trigger the WiFi scanning apparatus 400 to perform enhanced scanning operations for the selected AP. For example, the WiFi scanning apparatus 400 can be configured to lock to the channel of the selected AP and listen promiscuously for all packets coming from the selected AP. The WiFi details GUI can display an RSSI value for the selected AP, where the RSSI value updates every time a packet is observed from the selected AP. A scrolling or continuous graph of the observed RSSI for each packet from the selected AP can be rendered on the WiFi details GUI shown on the internal display 470. In some embodiments, the WiFi details GUI can include a scrolling chart or graph that indicates the activity of the selected AP in packets per second (e.g., a time-series or time history graph of the packets received from the selected AP).

In some aspects, the user input panel 454 and various GUIs of the internal display 470 user interface can be utilized by a user of the WiFi scanning apparatus 400 to select and initiate a WiFi snoop mode, which can allow the user to observe further activity related to a selected AP. For example, selecting the WiFi snoop mode can cause the WiFi scanning apparatus 400 to tune to the channel used by the selected AP, and begin listening for all packets to and from the selected AP. As packets transmitted to the selected AP are observed (e.g., collected by the WiFi scanning apparatus 400, for example using the directional antenna 415 seen in FIG. 4C), the internal display 470 can display a WiFi snoop GUI that includes a real-time listing of the connected or observed clients for the selected AP (e.g., a listing of each client that has been observed transmitting at least one packet to or otherwise associated with the selected AP). The listing may include a corresponding MAC address of each observed client associated with the selected AP. In some examples, the listing of clients associated with the selected AP can be sorted by the time in seconds since each respective client was last seen (e.g., the time in seconds since a packet from the respective client to the selected AP was last observed or collected by the WiFi scanning apparatus 400). The user input panel 454 can be used to change the sorting mode utilized for the listing of observed clients for the selected AP. For example, pressing the up or down buttons of the user input panel 454 can adjust the WiFi snoop GUI to sort the listing of connected clients of the selected AP by the last RSSI value observed for each respective connected client, the total number of packets seen from the respective connected client (either to the selected AP, or to any AP). In some embodiments, the WiFi snoop mode of the WiFi scanning apparatus 400, and the associated WiFi snoop GUIs of the internal display 470 user interface, can be used to provide greater insight into client devices within the vicinity of the WiFi scanning apparatus 400. For instance, in some embodiments the WiFi snoop mode and WiFi snoop GUIs of the WiFi scanning apparatus 400 can be used to identify rogue clients that are present in the area.

In some aspects, selecting the Bluetooth/BLE scan option from the main menu GUI can cause the internal display 470 user interface to present a default BLE screen (e.g., default BLE scan GUI) that is similar to the default WiFi scan GUI described above. For example, the BLE GUI can display information corresponding to the ongoing survey of BLE packets within the vicinity of the WiFi scanning apparatus 400 (e.g., the ongoing survey of BLE packets that can be detected or received using the directional antenna 315/415). For example, the BLE GUI can display results of the ongoing BLE scan, such as any or all BLE devices within range, as well as a respective RSSI of the BLE packets from each BLE device and/or the respective capabilities being advertised by each BLE device, etc. In some examples, the BLE GUI shown on the internal display 470 during the BLE scan can include one or more flags or other visual indications corresponding to appearance data, manufacturer data, service data, and service UUID for each observed BLE device. In some embodiments, the up and down arrows of the user input panel 454 can be used to scroll through the listing of BLE devices shown on the internal display 470 and the BLE scan GUI. Pressing the select button of the user input panel 454 can cause the internal display 470 to present a BLE details GUI, similar to the WiFi details GUI described above. Scrolling to the top of the page from the BLE details GUI can cause the WiFi scanning apparatus 400 to resume the BLE scan operations, again the same as or similar to the manner in which the WiFi scan operations are resumed by scrolling to the top of the WiFi scan details GUI.

The WiFi scan operation and WiFi scan GUI (and WiFi details GUI, WiFi snoop GUI, etc.) can be implemented based on WiFi sniffing or scanning operations implemented using the SOM 350, WiFi module 312, and directional antenna 315 shown in the architecture 300 of FIG. 3. The BLE scan operation and BLE scan GUI (and BLE details GUI, etc.) can be implemented based on Bluetooth/BLE sniffing or scanning operations that are likewise implemented using the SOM 350, Bluetooth module 316, and directional antenna 315 shown in the architecture 300 of FIG. 3.

A BLE details GUI shown on the internal display 470 during Bluetooth/BLE scanning operations can be similar to the WiFi details GUI described previously above. For example, the BLE details GUI can indicate the name of each BLE device observed (if advertised) during the Bluetooth/BLE packet collection, the MAC address, the last observed RSSI for each BLE device, elapsed time or seconds since a packet from the respective BLE device was last observed, etc. In some cases, the last observed RSSI for each listed BLE device can be continuously updated (e.g., every BLE packet detected or collected by the WiFi scanning apparatus 400 can be analyzed to identify the corresponding BLE device, and the RSSI value for the BLE packet can be used to update the last observed RSSI value shown in the listing of BLE devices in the BLE details GUI). In some examples, the BLE details GUI can further include an indication of the extended information included in the advertising frame associated with a respective BLE device of the listing and/or associated with one or more received (e.g., collected) BLE packets obtained by the WiFi scanning apparatus 400 during the Bluetooth/BLE scanning operations. In some embodiments, the WiFi scanning apparatus 400 can be configured to determine or identify the manufacturer of the respective BLE devices included in the listing of observed BLE devices. Identification of the manufacturer of a BLE device can be performed based on the extended information or other information included in the advertising frame, and identification of the manufacturer may depend at least in part on the type and/or quantity of information that is provided in the advertising frame. In some aspects, the BLE details GUI can include a graph or chart that is continuously or periodically updated to show the RSSI over time for a selected BLE device of the listing. The RSSI over time chart can be used to assist the user of the WiFi scanning apparatus 400 in locating the observed device (e.g., with the RSSI value over time increasing or decreasing as the distance between the WiFi scanning apparatus 400 and the particular observed BLE device of interest changes).

In some aspects, the main menu GUI shown on the internal display 470 can include a settings option that allows the user of the WiFi scanning apparatus 400 to configure, adjust, modify, etc., various settings, options, and/or configurations of the WiFi scanning apparatus 400 and the various WiFi, Bluetooth, BLE, etc., scanning operations performed. For example, a settings GUI can be shown on the internal display 470 and user inputs can be made to modify the settings or configurations to be used, via the user input panel 454. In some examples, the configurable settings can include, but are not limited to, settings such as the number of seconds to scan for Bluetooth classic devices (e.g., BCL_SCANTIME); a binary or Boolean flag for the performance of an active BLE scan (e.g., BCL_ACTIVE, set to either true/false or 1/0); a time to scan for BLE devices (e.g., BCL_SCANTIME, set to a number of seconds); a binary or Boolean flag for whether the internal display 470 will show a boot splash screen upon power on of the WiFi scanning apparatus 400 (e.g., SHOW_SPLASH, set to either true/false or 1/0); a binary or Boolean flag setting for whether to show WiFi BSIDs instead of ESSIDs (e.g., WIFI_BSSID, set to either true/false or 1/0); a time to dwell per channel, in a quantity of 100 ms windows (e.g., WIFI_DWELL, set to an integer value or multiplier of the 100 ms base time); a binary or Boolean flag setting for whether to show hidden WiFi SSIDs (e.g., WIFI_HIDDEN, set to either true/false or 1/0); a binary or Boolean flag setting for whether to use passive scanning for the WiFi scans performed by the WiFi scanning apparatus 400 (e.g., WIFI_PASSIVE, set to either true/false or 1/0); etc., among various other settings, configurations, or user options that can be input to adjust the operation of the WiFi scanning apparatus 400.

As shown in FIG. 4B, the enclosure 402 of the WiFi scanning apparatus 400 can include an external connector 442, shown here as a USB-C port or connector that can be used to provide electrical power to the WiFi scanning apparatus 400 (e.g., to charge the internal battery 380 of FIG. 3) and to provide a data connection between the WiFi scanning apparatus 400 and an external user computing device, etc. In some aspects, the USB input connector 442 can be provided as a waterproof, weather-sealed, weather-resistant, etc., input connector to prevent the ingress of foreign substances to the interior of the enclosure 402. In some examples, the USB input connector 442 can be used to offload data from the WiFi scanning apparatus 400 (e.g., collected packet scan and PPI geolocation metadata information, etc.) to a separate computing device for further analysis, visualization, or use. The USB input connector 442 can additionally be used to provide an interface between the external computing device and the SOM 350 shown in FIG. 3, thereby allowing user configurations and commands to be transmitted from the external computing device to the WiFi scanning apparatus 300/400 and associated SOM 350, via the data connection provided by the USB input connector 442. In some aspects, the USB input connector 442 can be used to provide a command line interface to the WiFi scanning apparatus 400 and the Linux or Linux-based SOM 350 thereof, enabling further user customization or development for the WiFi scanning apparatus 300/400 and the various WiFi scanning, collection, routines, etc., performed using the WiFi scanning apparatus 300/400.

In some examples, the WiFi scanning apparatus 400 can be implemented as a handheld device that can be used in the field and moved (e.g., by the user) from location to location for performing various scans. In some embodiments, the housing 402 is sized for portable and handheld use of the WiFi scanning apparatus 400 by the user. For example, the housing 402 may have dimensions of approximately 4-5″ along the longitudinal axis 407 and a width of approximately 3-4″ perpendicular to the longitudinal axis 407, although it is noted that various other dimensions and sizes of the housing 402 may also be used without departing from the scope of the disclosure. In some aspects, a width of the WiFi scanning apparatus 400 (e.g., the width including the housing 402 and the optional external optic/monocular/scanning scope 490 attached thereto) can be approximately 5-6″. In some examples, the distance between the center of the user viewing aperture 405 and the center of the view aperture of the external optic/monocular/scanning scope 490 (e.g., the distance between longitudinal axis 407 and the optical viewing axis 497 shown in FIG. 4A) can be approximately 2.5-3″. In some examples, the height of the enclosure 402 can be approximately 2-3″. The example dimensions above are given for purposes of clarity of illustration and example and are not intended to be construed as limiting with respect to “handheld”.

The external optic 490 can, in some embodiments, be optionally provided. In other words, the WiFi scanning apparatus(es) described herein, such as the WiFi scanning apparatus 300 of FIG. 3, the WiFi scanning apparatus 400 of FIGS. 4A-4C, etc., can be fully functional and utilized both with and without the external optic 490 attached to the housing 302/402. In some examples, the external optic 490 can be provided or implemented as a monocular or spotting scope that provides a magnified view to the user of the area in front of the longitudinal axis 407 (corresponding to the direction of increased gain of the directional antenna 315/415 for performing the WiFi scan or collection), where the magnified view allows the user to more precisely aim or position the handheld WiFi scanning apparatus 400 to perform the scan or collection at the desired location. In some embodiments, the optional external optic 490 can be implemented as a monocular or spotting scope with 7-21× adjustable zoom, among various other zoom levels or zoom ranges. The optional external optic 490 and the housing 402 can both comprise a plastic material construction, to minimize RF impact with the directional antenna 415 used to perform the packet collection of the WiFi scanning operations. In some examples, the external optic 490 can be used to allow the user of the WiFi scanning apparatus 400 to perform the WiFi scan or collection at a desired standoff or distance to the target area for acquisition. The external optic 490 can include a rangefinder and/or range indicator to provide the user with a distance to the imaged area shown in the magnified view along the optical viewing axis 497 seen through the external optic or scope 490. In some aspects, the external optic 490 can include or support Bluetooth communications, such that the external optic 490 can pair with or establish a Bluetooth connection with the WiFi scanning apparatus 400. For example, a Bluetooth-enabled or Bluetooth-capable external optic or spotting scope 490 can establish and perform Bluetooth communications with the SOM 350 and/or the Bluetooth module 316 shown in the example architecture 300 of FIG. 3, etc.

FIGS. 5A-5C illustrate various perspective views of a directional antenna of a handheld WiFi scanning apparatus, in accordance with some examples. For example, the directional antenna 515-1 and/or 515-2 shown in FIGS. 5A-5C can be the same as or similar to the directional antenna 315 of FIG. 3 and/or the directional antenna 415 of FIG. 4C.

In some aspects, the directional antenna 515 can be implemented as a custom WiFi antenna that is packaged internal to the non-metallic enclosure (e.g., enclosure 302 of FIG. 3, enclosure 402 of FIGS. 4A-4B, etc.) used to implement the handheld WiFi scanning apparatus (e.g., WiFi scanning apparatus 300 of FIG. 3, 400 of FIGS. 4A-4C, etc.). The directional antenna 515 can be configured to provide a directed pattern in the pointing direction of the WiFi scanning apparatus. As noted previously, the pointing direction (e.g., direction of maximum or increased gain of the directional antenna 515) can be the same as or similar to the direction of the longitudinal axis 407 and the viewing/optical axis 497 shown in FIGS. 4A-4C.

As used herein, the directional antenna 515 can collectively refer to the antennas 515-1 and 515-2 shown in FIGS. 5A-5C. In some aspects, the antennas 515-1 and 515-2 can correspond to WiFi antenna ports and Bluetooth antenna ports of the directional antenna 515. The directional antenna can, in at least some aspects, be implemented to provide a 50-60 degree 3 dB beamwidth and 8-9 dB gain, although it is noted various other directional antenna configurations, parameters, etc., can also be utilized to provide the increased gain in the pointing direction for WiFi collection by the WiFi scanning apparatus disclosed herein. In some cases, the directional antenna 515 can have a modified rectangular outline for the antenna base, for instance 81 mm×55 mm with corner cutouts and support notches for attachment to (e.g., within) the interior volume of the housing/enclosure 402 of the WiFi scanning apparatus 400, etc.

As shown in the examples of FIGS. 5A-5C, the directional antenna 515 (e.g., antennas 515-1 and 515-2, etc.) can be provided within the interior volume of an enclosure 502, which may be the same as or similar to the enclosure 302 of FIG. 3 and/or the enclosure 402 of FIGS. 4A-4C. In some aspects, an outer shell for the antenna (e.g., a portion of the enclosure 502 located at and about the directional antenna 515) can be implemented as a radome, that is RF transparent for transmissions and receptions using the directional antenna 515. In some embodiments, the central antenna portion 515-1 can comprise a Bluetooth antenna (e.g., and may be coupled via a corresponding Bluetooth antenna port to the Bluetooth module 316 and/or SOM 350 of FIG. 3). The two lateral antenna portions 515-2 can comprise WiFi antennas, such as a 2.4 GHz band WiFi antenna and a 5 GHz band WiFi antenna, and may be coupled via corresponding WiFi antenna ports to the WiFi module 314 and/or SOM 350 of FIG. 3. In some embodiments, the directional antenna 515 can be configured with the Bluetooth antenna portion 515-1 and the WiFi antenna portions 515-2 nested with their respective top surfaces at different height levels (e.g., with height here referring to the up-down direction in the perspectives shown in FIGS. 5A-5C). For example, the two WiFi directional antenna portions 515-2 can be nested underneath the central Bluetooth antenna portion 515-1, as seen in FIGS. 5B and 5C where the Bluetooth antenna 515-1 is shown at a greater height than the two WiFi antennas 515-2. In some examples, the WiFi antennas 515-2 can be provided at the same height as one another, and may both be nested (e.g., in the height or z-direction) underneath the overhanging Bluetooth antenna 515-1.

FIGS. 6-10 are diagrams illustrating example visualizations of different WiFi scans results and scan locations that can be associated with WiFi sniffing or scanning operations performed using the presently disclosed WiFi scanning apparatus (e.g., the WiFi scanning apparatus of any of FIGS. 4-5C, etc.).

FIG. 6 is a diagram illustrating an example of WiFi scan results 600 that do not include PPI geolocation metadata, such as the PPI geolocation metadata that can be embedded in the WiFi survey and collection data performed using the presently disclosed WiFi scanning apparatus. For example, the visualization of the WiFi scan results 600 shown in FIG. 6 can be obtained based on performing a WiFi survey without PPI geolocation on or otherwise enabled. Here, a plurality of survey or scan points are shown, each indicated as a vertical bar in the visualization of FIG. 6. Each point and corresponding vertical bar indicates a GPS location and corresponding signal strength of a particular (e.g., selected) WiFi AP in relation to that particular GPS location.

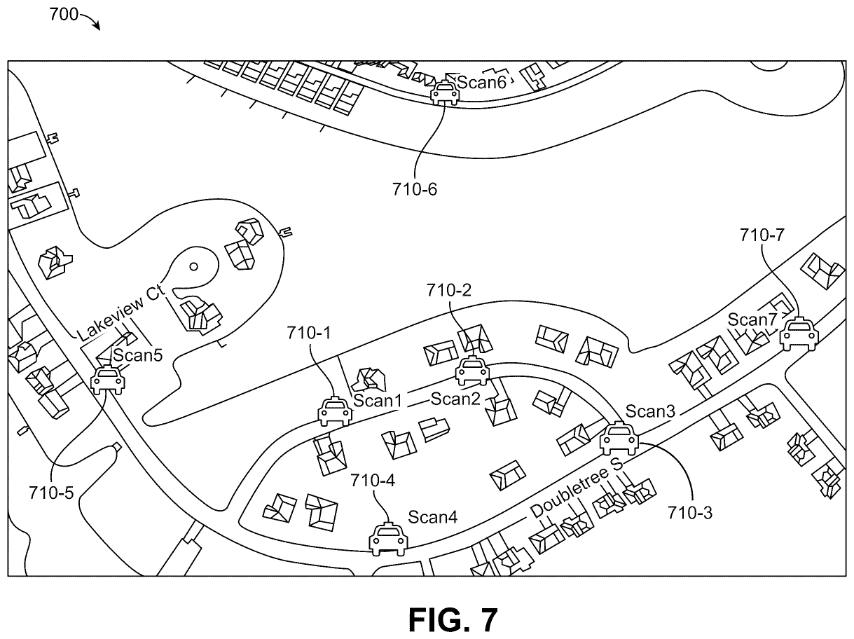

FIG. 7 is a diagram 700 illustrating a plurality of WiFi scan locations that can be used to perform WiFi surveys (e.g., scanning, sniffing, collection, etc.) with PPI geolocation data, in accordance with some examples. The plurality of WiFi scan locations are superimposed on the map view presented in FIG. 7, for example showing eight discrete scan locations 710-1, 710-2, 710-3, 710-4, 710-5, 710-6, 710-8.

Based on performing WiFi surveys at the plurality of WiFi scan locations 710-1-710-8 (collectively referred to as the scan locations 710), and obtaining PPI geolocation data comprising at least a GPS location and a heading orientation pointing vector corresponding to the WiFi scanning apparatus at the time of collection for each collected WiFi packet, an improved WiFi survey and subsequent visualization can be performed. For instance, the PPI geolocation data can be obtained using the GPS module 330 and GPS antenna 335 of FIG. 3, and the magnetic compass 320 of FIG. 3 (and in some cases, further based on the magnetometer 342 and/or accelerometer 344 of FIG. 3).

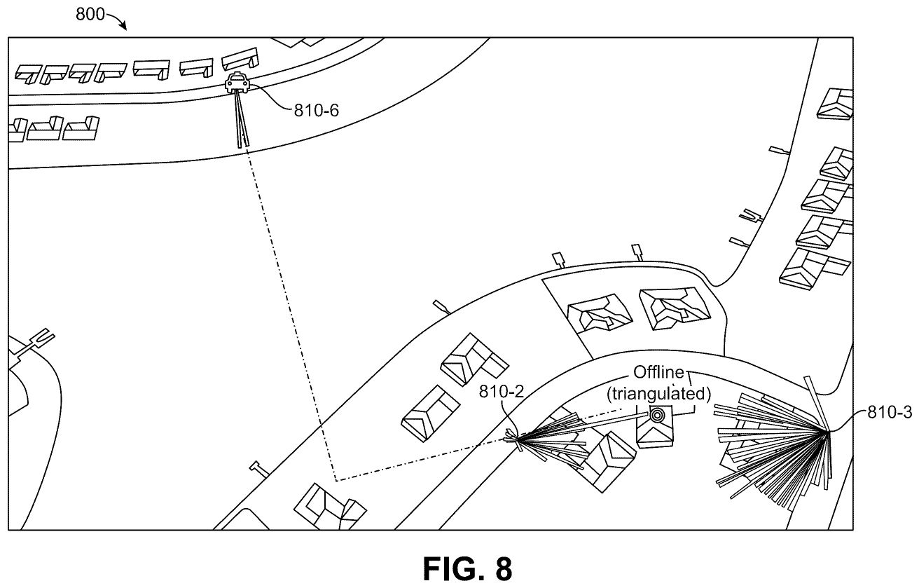

Based on augmenting the WiFi survey data (e.g., collected WiFi packets) with the PPI geolocation metadata, the plurality of WiFi scan locations 710 can be correlated to the set of observed APs. As such, the PPI geolocation WiFi survey data can be visualized with each measurement or collected packet mapped to a corresponding AP, as shown in the examples of FIGS. 8-10, rather than mapping each measurement or collected packet to a location coordinate alone (e.g., as in the example visualization of the WiFi scan results 600 shown in FIG. 6).

For example, the PPI geolocation metadata and collected WiFi packets obtained at each of the scan locations 710 can be analyzed to triangulate the respective location of each observed WiFi AP. In the example of FIG. 8, which shows a PPI-based WiFi scan visualization 800, a WiFi scan location 810-6 is shown, which can be the same as or similar to the WiFi scan location 710-6 of FIG. 7. Likewise, a WiFi scan location 810-2 shown in FIG. 8 can be the same as or similar to the WiFi scan location 710-2 of FIG. 7, and a WiFi scan location 810-3 of FIG. 8 can be the same as or similar to the WiFi scan location 710-3 of FIG. 7.

The PPI geolocation data can be used to map each collected WiFi packet to a particular scan location, based on the GPS geolocation information of the PPI metadata. Additionally, the heading orientation or pointing vector data also included in the PPI metadata for the collected WiFi packets can be used to triangulate the WiFi AP locations. For example, based on the location where a WiFi packet was collected, and the heading orientation at the time of collection, the signal strength or RSSI of the collected WiFi packet can used to triangulate the precise location of the corresponding AP for the collected WiFi packet. In the example of FIG. 8, the plurality of WiFi measurements are shown after being triangulated to and correlated based on their PPI metadata, with the length of each line indicating the RSSI or signal strength of the collection/measurement and the angle (e.g. heading orientation) of each line indicating the pointing direction of the longitudinal axis 407 of the WiFi scanning apparatus 400 at the time of the collection/measurement. In particular, FIG. 8 shows an example where a packet from an AP ‘offline’ is triangulated to the 810-2 location after being received at the 810-6 location (e.g., based on the triangulated packet being transmitted from the AP ‘offline’ and reflecting off of homes or other objects in the environment to thereby be collected at the 810-6 scan location). In the example of FIG. 8, the reflection path of the packet triangulated to the ‘offline’ AP and/or 810-2 scan location, after being collected at the 810-6 scan location, is indicated with the two dashed lines.

In some aspects, the visualizations shown in the examples of FIGS. 6-10, and the associated triangulation of WiFi AP locations and/or connected client locations can be performed based on the PPI data embedded in the PCAP files generated by the WiFi scanning apparatus 300/400, for instance during post-processing or analysis operations performed on a user's computing device after offloading the PCAP files (with embedded PPI geolocation metadata) from the WiFi scanning apparatus 300/400 to the user's computing device.

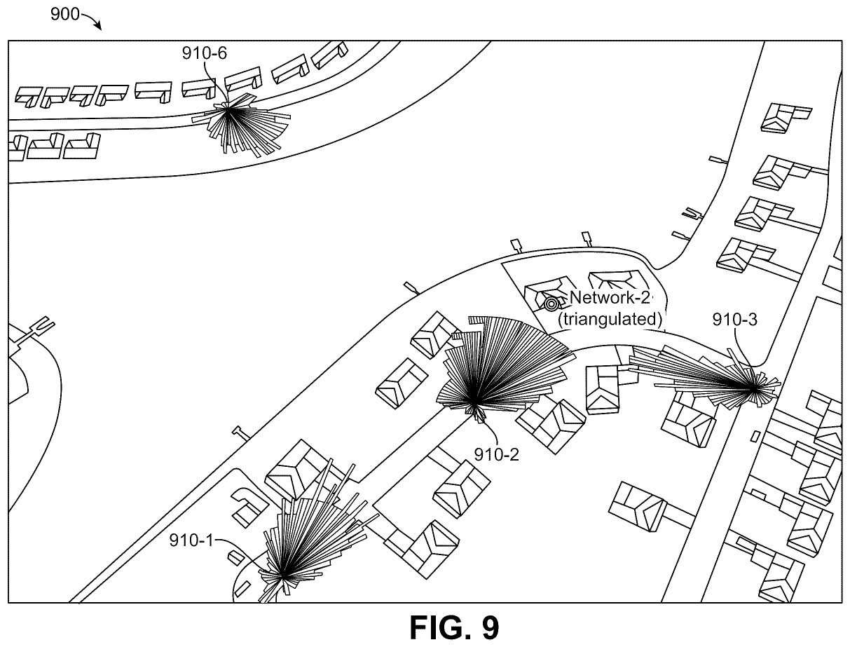

FIG. 9 is a diagram illustrating an example visualization 900 of WiFi scan data corresponding to a detected or observed WiFi AP ‘Network-2’, where the collected WiFi packets and WiFi survey data are obtained using the WiFi scanning apparatus 300/400 and include the embedded PPI geolocation information and/or PPI metadata that can be used for accurately triangulating the location of a selected WiFi AP (e.g., in this example, for accurately triangulating the location of the selected WiFi AP ‘Network-2’). In some examples, the scan locations 910-1, 910-2, 910-3, and 910-6 shown in FIG. 9 can be the same as or similar to the scan locations 710-1, 710-2, 710-3, and 710-6 (respectively) of FIG. 7; the scan locations 810-2, 810-3, and 810-6 (respectively) of FIG. 8; etc.

In some aspects, for each of the depicted WiFi scan locations, the disclosed WiFi scanning apparatus 300 of FIG. 3, 400 of FIG. 4, etc., can be used to obtain a plurality of WiFi packets with corresponding PPI geolocation and/or metadata information for each packet of the plurality of WiFi packets. Based on the heading orientation or pointing vector information included in the embedded PPI geolocation metadata for each collected packet, the visualization 900 can indicate the signal strength (e.g., RSSI, etc.) with which each collected packet was obtained or received by the WiFi scanning apparatus 300/400 based on the length, color, width, size, etc., of the line or bar used to visually represent the collected packet. The angle or heading orientation with which the line or bar for each collected packet is shown in the visualization 900 can be the same as or otherwise derived from the angle or heading orientation included in the embedded PPI geolocation metadata associated with the collected packet. Collected packets can be correlated to or sorted to one of the configured scan locations (e.g., one of the scan locations 910-1, 910-2, 910-3, 910-6) based on the GPS and/or other location or positioning information included in the embedded PPI geolocation metadata associated with the collected packet (e.g., altitude, attitude, etc.). In some cases, the subset of the collected packets associated with a particular scan location can have similar GPS locations and heading orientations in the respective PPI geolocation metadata embedded in each packet of the subset of collected packets.

For example, a first subset of collected packets can be associated to the scan location 910-1, where the first subset of collected packets have a similar range of heading orientations to the ‘Network-2’WiFi AP that is the target of interest for the WiFi scanning, and/or have a similar range of RSSI or signal strength values (e.g., based on being collected at approximately the same distance to the ‘Network-2’WiFi AP, i.e. the distance from scan location 910-1 to the physical ‘Network-2’WiFi AP). A second subset of collected packets can be associated to the scan location 910-2, where the second subset of collected packets have a similar range of heading orientations and/or signal strengths to one another. Here, the range of angles or heading orientations of the collected packets of the second subset (e.g., collected from scan location 910-2) can be the same as or similar to the range of angles or heading orientations of the collected packets of the first subset (e.g., collected from scan location 910-1). The first and second subset of collected packets can be differentiated using additional information from the embedded PPI geolocation metadata, such as the GPS location (e.g., based on the first and second scan locations 910-1, 910-2 corresponding to different location coordinates), the time of collection, the RSSI or signal strength (E.g., based on the first location 910-1 being closer to the ‘Network-2’WiFi AP and therefore having a stronger average RSSI value than the second location 910-2, which is farther away from the ‘Network-2’WiFi AP, etc.).

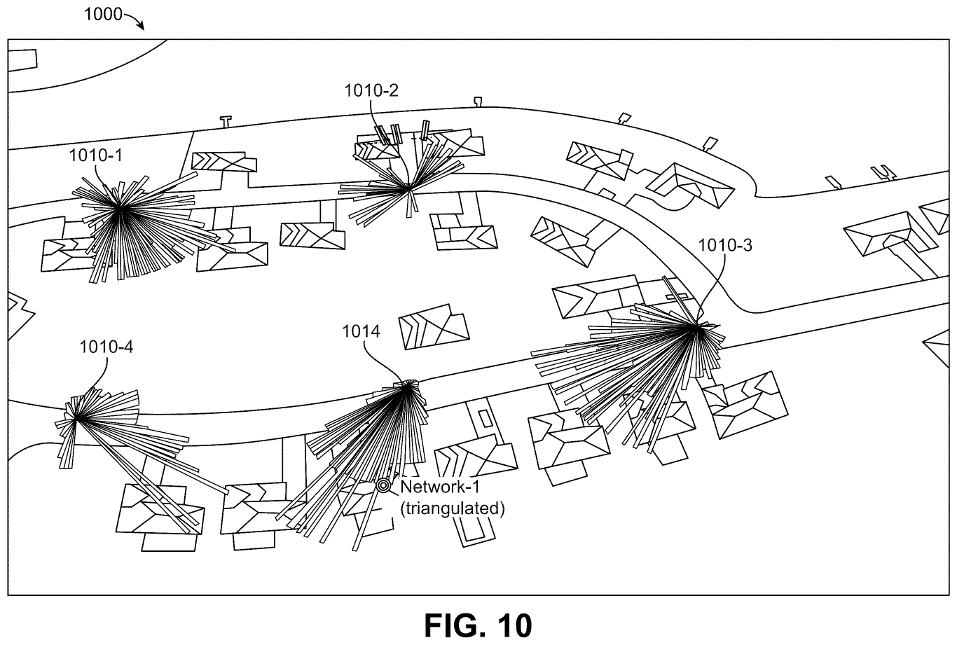

FIG. 10 is a diagram illustrating another example visualization 1000 of WiFi scan data obtained from a plurality of scan locations and associated with Per Packet Information (PPI), in accordance with some examples. For instance, the visualization 1000 of FIG. 10 can correspond to a detected or observed WiFi AP ‘Network-1’, which can be location triangulated based on the observations and/or WiFi scans or collections obtained from the plurality of scan locations 1010-1, 1010-2, 1010-3, 1010-4, 1014. In some aspects, the scan location 1010-1 can be the same as or similar to the scan location 710-1 of FIG. 7, 910-1 of FIG. 9, etc. The scan location 1010-2 of FIG. 10 can be the same as or similar to the scan location 710-2 of FIG. 7, 810-2 of FIG. 8, 910-2 of FIG. 9, etc. The scan location 1010-3 of FIG. 10 can be the same as or similar to the scan location 710-3 of FIG. 7, 810-3 of FIG. 8, 910-3 of FIG. 9, etc. In some aspects, the scan location 1010-4 of FIG. 10 can be the same as or similar to the scan location 710-4 of FIG. 7, etc.

In some aspects, for each of the depicted WiFi scan locations of FIG. 10, the disclosed WiFi scanning apparatus 300 of FIG. 3, 400 of FIG. 4, etc., can be used to obtain a plurality of WiFi packets with corresponding PPI geolocation and/or metadata information for each packet of the plurality of WiFi packets. Based on the heading orientation or pointing vector information included in the embedded PPI geolocation metadata for each collected packet, the visualization 1000 can indicate the signal strength (e.g., RSSI, etc.) with which each collected packet was obtained or received by the WiFi scanning apparatus 300/400 based on the length, color, width, size, etc., of the line or bar used to visually represent the collected packet. The angle or heading orientation with which the line or bar for each collected packet is shown in the visualization 1000 can be the same as or otherwise derived from the angle or heading orientation included in the embedded PPI geolocation metadata associated with the collected packet. Collected packets can be correlated to or sorted to one of the configured scan locations (e.g., one of the scan locations 1010-1, 1010-2, 1010-3, 1010-4, 1014, etc.), based on the GPS and/or other location or positioning information included in the embedded PPI geolocation metadata associated with the collected packet (e.g., altitude, attitude, etc.). In some cases, the subset of the collected packets associated with a particular scan location can have similar GPS locations and heading orientations in the respective PPI geolocation metadata embedded in each packet of the subset of collected packets.

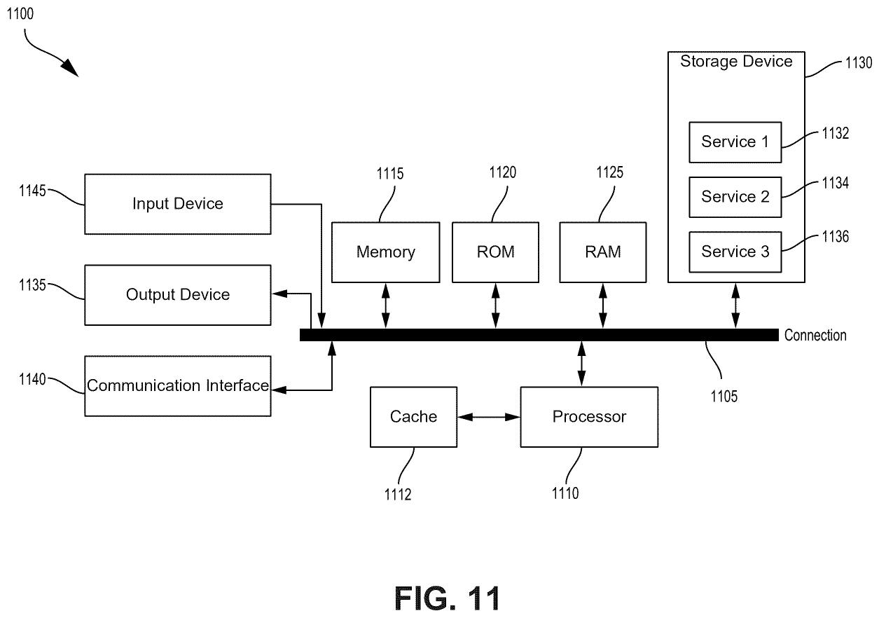

FIG. 11 illustrates an example computing device architecture 1100 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. The components of computing device architecture 1100 are shown in electrical communication with each other using connection 1105, such as a bus. The example computing device architecture 1100 includes a processing unit (CPU or processor) 1110 and computing device connection 1105 that couples various computing device components including computing device memory 1115, such as read only memory (ROM) 1120 and random-access memory (RAM) 1125, to processor 1110.

Computing device architecture 1100 can include a cache of high-speed memory connected directly with, in close proximity to, or integrated as part of processor 1110. Computing device architecture 1100 can copy data from memory 1115 and/or the storage device 1130 to cache 1112 for quick access by processor 1110. In this way, the cache can provide a performance boost that avoids processor 1110 delays while waiting for data. These and other engines can control or be configured to control processor 1110 to perform various actions. Other computing device memory 1115 may be available for use as well. Memory 1115 can include multiple different types of memory with different performance characteristics. Processor 1110 can include any general-purpose processor and a hardware or software service, such as service 1 1132, service 2 1134, and service 3 1136 stored in storage device 1130, configured to control processor 1110 as well as a special-purpose processor where software instructions are incorporated into the processor design. Processor 1110 may be a self-contained system, containing multiple cores or processors, a bus, memory controller, cache, etc. A multi-core processor may be symmetric or asymmetric.

To enable user interaction with the computing device architecture 1100, input device 1145 can represent any number of input mechanisms, such as a microphone for speech, a touch-sensitive screen for gesture or graphical input, keyboard, mouse, motion input, speech and so forth. Output device 1135 can also be one or more of a number of output mechanisms known to those of skill in the art, such as a display, projector, television, speaker device, etc. In some instances, multimodal computing devices can enable a user to provide multiple types of input to communicate with computing device architecture 1100. Communication interface 1140 can generally govern and manage the user input and computing device output. There is no restriction on operating on any particular hardware arrangement and therefore the basic features here may easily be substituted for improved hardware or firmware arrangements as they are developed.

Storage device 1130 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1125, read only memory (ROM) 1120, and hybrids thereof. Storage device 1130 can include services 1132, 1134, 1136 for controlling processor 1110. Other hardware or software modules or engines are contemplated. Storage device 1130 can be connected to the computing device connection 1105. In one aspect, a hardware module that performs a particular function can include the software component stored in a computer-readable medium in connection with the necessary hardware components, such as processor 1110, connection 1105, output device 1135, and so forth, to carry out the function.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as flash memory, memory or memory devices, magnetic or optical disks, flash memory, USB devices provided with non-volatile memory, networked storage devices, compact disk (CD) or digital versatile disk (DVD), any suitable combination thereof, among others. A computer-readable medium may have stored thereon code and/or machine-executable instructions that may represent a procedure, a function, a subprogram, a program, a routine, a subroutine, a module, an engine, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

What is claimed is:

1. An apparatus for wireless communications, the apparatus comprising:
a housing defining an enclosed volume and a pointing direction of the apparatus, wherein the pointing direction corresponds to a longitudinal axis of the housing;
one or more directional antennas disposed within the enclosed volume of the housing, wherein the one or more directional antennas are configured to provide directionality for increased gain in the pointing direction of the apparatus along the longitudinal axis;
a WiFi chipset module coupled to the one or more directional antennas and configured to collect a plurality of collected packets from one or more access points (APs) in the pointing direction of the apparatus using the one or more directional antennas;
a positioning system configured to determine a location and a heading orientation of the apparatus corresponding to a time of collection for each collected packet of the plurality of collected packets; and
a system-on-module (SOM) communicatively coupled to the WiFi chipset module and the positioning system, wherein the SOM generates WiFi scan data comprising the plurality of collected packets and a respective geolocation metadata indicative of the location and the heading orientation determined for each collected packet of the plurality of collected packets.

2. The apparatus of claim 1, wherein the respective geolocation metadata for each collected packet comprises Per Packet Information (PPI) data.

3. The apparatus of claim 1, wherein the WiFi scan data comprises packet capture (PCAP) data, and wherein the respective geolocation metadata for each collected packet comprises Per Packet Information (PPI) data embedded within the PCAP data.

4. The apparatus of claim 1, wherein the respective geolocation metadata for each collected packet further includes one or more of:
an altitude of the apparatus corresponding to the time of collection of each collected packet; or
an angle of attack associated with the apparatus receiving the collected packet using the one or more directional antennas.

5. The apparatus of claim 1, wherein the positioning system comprises:
a Global Navigation Satellite System (GNSS) receiver and a corresponding GNSS antenna, wherein the location of the apparatus corresponding to the time of collection for each collected packet is determined by the GNSS receiver in response to a query from the SOM.

6. The apparatus of claim 5, wherein the GNSS receiver comprises a Global Positioning System (GPS) receiver, and wherein the corresponding GNSS antenna comprises a GPS antenna.

7. The apparatus of claim 1, wherein the positioning system comprises a magnetic compass configured to determine the heading orientation of the apparatus corresponding to the time of collection for each collected packet, and wherein the heading orientation is determined by the magnetic compass in response to a query from the SOM.

8. The apparatus of claim 1, wherein:
the positioning system includes one or more of a magnetometer or an accelerometer; and
the respective geolocation metadata determined for each collected packet further includes one or more of a respective magnetic field information determined using the magnetometer at the time of collection for each collected packet, or a respective acceleration information determined using the accelerometer at the time of collection for each collected packet.

9. The apparatus of claim 1, further comprising a Bluetooth chipset module coupled to the one or more directional antennas and configured to collect a plurality of Bluetooth packets from one or more Bluetooth devices in the pointing direction of the apparatus, using the one or more directional antennas.

10. The apparatus of claim 9, wherein:
the WiFi chipset is configured by the SOM to perform WiFi scanning operations in the pointing direction, based on using one or more WiFi directional antennas included in the one or more directional antennas.

11. The apparatus of claim 10, wherein the one or more directional antennas includes at least a first WiFi directional antenna configured to perform WiFi scanning operations for collecting WiFi packets associated with a first WiFi band, and a second WiFi directional antenna configured to perform WiFi scanning operations for collecting WiFi packets associated with a second WiFi band.

12. The apparatus of claim 11, wherein the first WiFi directional antenna is associated with collecting WiFi packets on a 2.4 gigahertz (GHz) WiFi band, and the second WiFi directional antenna is associated with collecting WiFi packets on a 5 GHz WiFi band.

13. The apparatus of claim 9, wherein:
the Bluetooth chipset module is configured to perform Bluetooth scanning operations in the pointing direction, based on using one or more Bluetooth directional antennas included in the one or more directional antennas.

14. The apparatus of claim 13, wherein the one or more directional antennas includes at least a first Bluetooth directional antenna configured to collect Bluetooth or Bluetooth Low Energy (BLE) packets transmitted from Bluetooth devices in the pointing direction of the apparatus.

15. The apparatus of claim 1, wherein the SOM is a Linux-based SOM and provides a user interface for implementing one or more user configuration inputs corresponding to WiFi scanning or packet collection operations of the apparatus.

16. The apparatus of claim 1, wherein the apparatus is configured to perform WiFi scanning or WiFi sniffing based on one or more of enabling a monitor mode of the WiFi chipset module, or performing packet injection using the WiFi chipset module.

17. The apparatus of claim 1, further comprising:
an external optic coupled to an outer surface of the housing, wherein an optical viewing axis of the external optic is aligned with the pointing direction of the apparatus and the longitudinal axis of the housing.

18. The apparatus of claim 17, wherein the external optic comprises a monocular or a spotting scope detachably coupled to the outer surface of the housing.

19. The apparatus of claim 17, wherein a field of view of the external optic corresponds to an area of maximum gain of the one or more directional antennas in the pointing direction of the apparatus.

20. The apparatus of claim 1, wherein:
the housing comprises a handheld enclosure formed from radio frequency (RF) transparent materials; and
the apparatus further includes a rechargeable battery disposed within the enclosed volume of the housing and configured to power the apparatus during WiFi or Bluetooth scanning and packet collection operations.
